(19) United States
(12) Patent Application Publication
(10) Pub. No.: US 2005/0065237 A1
(43) Pub. Date: Mar. 24, 2005

(54) Process for making surface treated absorbent gelling material

(75) Inventors: Mattias Schmidt, Idstein (DE); Axel Meyer, Frankfurt am (DE); Bruno Johannes Ehrnsperger, Mason, OH (US); Stephen Allen Goldman, Montgomery, OH (US); Michael Divo, Friedrichsdorf (DE); Edward Joseph Urankar, Mason, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/912,332

(22) Filed: Aug. 5, 2004

Related U.S. Application Data
(60) Provisional application No. 60/492,820, filed on Aug. 6, 2003.

(51) Int. Cl. C08K 9/10

(52) U.S. Cl. 523/210

(57) ABSTRACT

This invention is directed to a process for making surface treated absorbent gelling material by treating partially swollen absorbent gelling polymers, which have a specific water content with a treatment agent, such as a coating agent, and subsequently removing at least part of the water. The treatment agent thus typically forms a shell on the polymers or part thereof, which can extend when the polymers swell in water; thus, the treatment shell or coating does not rupture when the polymers swell in a liquid, e.g., water or saline water, the coating being extensible in wet state. The treatment agent comprises preferably an elastomeric polymeric material. The invention also relates to surface-treated absorbent gelling material obtainable by the process of the invention, and to products, e.g., disposable absorbent articles, comprising such material.

### CROSS REFERENCE TO RELATED APPLICATIONS

This application claims the benefit of U.S. Provisional Application No. 60/492,820, filed Aug. 6, 2003.

### FIELD OF THE INVENTION

This invention is directed to a process for making surface treated absorbent gelling materials by treating absorbent gelling polymers, which have a specific water content with a treatment agent, such as a surface cross-linking agent or a coating agent, and subsequently removing at least part of the water. The treatment agent typically forms a shell on the polymers or a portion thereof, which can extend when the polymers swell in water; thus, the treatment shell or coating agent does not rupture when the polymers swell in a liquid, e.g., water or saline water, since the coating is extensible in wet state. The treatment agent comprises preferably an elastomeric polymeric material. The invention also relates to surface-treated absorbent gelling material obtainable by the process of the invention, and to products, e.g., disposable absorbent articles, comprising such material.

### BACKGROUND OF THE INVENTION

An important component of disposable absorbent articles such as diapers is an absorbent core structure comprising water-swellable polymers, typically hydrogel-forming water-swellable polymers, also referred to as absorbent gelling material, AGM, or super-absorbent polymers, or SAP's. This polymer material ensures that large amounts of bodily fluids, e.g., urine, can be absorbed by the article during its use and locked away, thus providing low rewet and good skin dryness.

Especially useful water-swellable polymer materials or SAP's are often made by initially polymerizing unsaturated carboxylic acids or derivatives thereof, such as acrylic acid, alkali metal (e.g., sodium and/or potassium) or ammonium salts of acrylic acid, alkyl acrylates, and the like in the presence of relatively small amounts of di- or poly-functional monomers such as N,N′-methylenebisacrylamide, trimethylolpropane triacrylate, ethylene glycol di(meth)acrylate, or triallylamine. The di- or poly-functional monomer materials serve to lightly cross-link the polymer chains thereby rendering them water-insoluble, yet water-swellable. These lightly crosslinked absorbent polymers contain a multiplicity of carboxyl groups attached to the polymer backbone. It is generally believed, that these carboxyl groups generate a driving force for the absorption of body fluids by the crosslinked polymer network.

In addition, the polymer particles are often treated as to form a surface cross-linking ‘coating’ on the outer surface in order to improve their properties in particular for application in baby diapers.

Water-swellable (hydrogel-forming) polymers useful as absorbents in absorbent members and articles such as disposable diapers need to have adequately high sorption capacity, as well as adequately high gel strength. Sorption capacity needs to be sufficiently high to enable the absorbent polymer to absorb significant amounts of the aqueous body fluids encountered during use of the absorbent article. Together with other properties of the gel, gel strength relates to the tendency of the swollen polymer particles to deform under an applied stress, and the gel strength needs to be high enough so that the particles do not deform and fill the capillary void spaces in the absorbent member or article to an unacceptable degree, so-called gel blocking. This gel-blocking inhibits the rate of fluid uptake or the fluid distribution, i.e., once gel-blocking occurs, it can substantially impede the distribution of fluids to relatively dry zones or regions in the absorbent article and leakage from the absorbent article can take place well before the water-swellable polymer particles are fully saturated or before the fluid can diffuse or wick past the “blocking” particles into the rest of the absorbent article. Thus, it is important that the water-swellable polymers (when incorporated in an absorbent structure or article) maintain a high wet-porosity and have a high resistance against deformation thus yielding high permeability for fluid transport through the swollen gel bed.

Absorbent polymers with relatively high permeability can be made by increasing the level of internal crosslinking or surface crosslinking, which increases the resistance of the swollen gel against deformation by an external pressure such as the pressure caused by the wearer, but this typically also reduces the absorbent capacity of the gel undesirably.

The inventors found that often the surface crosslinked water-swellable polymer particles are constrained by the surface-crosslinking ‘shell’ and cannot absorb and swell sufficiently, and/or that the shell is not strong enough to withstand the stresses of swelling or the stresses associated with performance under load.

The inventors have found that the coatings or shells of the water-swellable polymers, as used in the art, including surface cross-linking ‘coatings’, break when the polymer swells significantly or that the ‘coatings’ break after having been in a swollen state for a period of time. They also found that, as a result thereof, the coated and/or surface-crosslinked water-swellable polymers or super-absorbent material known in the art deform significantly in use thus leading to relatively low porosity and permeability of the gel bed in the wet state. They found that this could be detrimental to the optimum absorbency, liquid distribution or storage performance of such polymer materials.

Thus, the inventors found that what is required are water-swellable materials comprising coated water swellable polymers that have a coating that can exert a force in the wet state and that does substantially not rupture when the polymers swell in body liquid under typical in-use conditions. In the context of this invention, the inventors have found that as a good representative for body liquids such as urine, a 0.9% sodium chloride by weight in water solution, further called “0.9% saline” can be used. Therefore the inventors have found that it is required to have coated water swellable materials where the coating does substantially not rupture when the materials swell in 0.9% saline.

The inventors have now developed a process to make new and improved surface-treated absorbent gelling materials, comprising water-swellable polymers that are treated with a treatment agent, such as a coating and/or a surface cross-linking agent, such that the treatment shell or coating can extend and remains intact, i.e. without breaking, when the polymers swell. The inventors found that by applying the treatment agent on water-swellable polymers which are already in a partially swollen state due to absorption of a liquid (e.g., water) and by then subsequently removing (part of) the liquid in the treated polymers, an absorbent gelling material is obtained which has a treatment shell or coating that can extend when the material absorbs water in use, without a large internal stress on the treatment shell or coating by the swelling of the polymers. The resulting surface treated absorbent gelling material has thus a more robust surface coating or shell, which can better withstand stress caused by swelling of the polymer core, because it extends when the polymers in the polymer core swell and extend.

### SUMMARY OF THE INVENTION

The present invention relates to a process for making surface-treated absorbent gelling materials that comprises water-swellable polymers, said process comprising the steps of:
a) obtaining absorbent gelling material that contains per gram of absorbent gelling material at least 4 gram of liquid, e.g., water;
b) treating the surface of the absorbent gelling material of step a) with a treatment agent;
c) simultaneously with or subsequent to step b), removing at least a part of the water from said absorbent gelling material, to obtain surface-treated absorbent gelling material containing less than 50% by weight of the material of moisture, (and optionally comprising a curing step).

In a second embodiment, the invention relates to a process for making surface-treated absorbent gelling material that comprises water-swellable polymers, said process comprising the steps of:
a) obtaining absorbent gelling material that contains per gram of absorbent gelling material at least 1.0 gram of water and that has a CCRC of at least 60 g/g;
b) treating the surface of the absorbent gelling material of step a) with a treatment agent;
c) simultaneously with or subsequent to step b), removing at least a part of the water from said absorbent gelling material, to obtain surface-treated absorbent gelling material containing less than 50% by weight of the material of moisture, (and optionally comprising a curing step).

When used herein, the water contained in the absorbent gelling material may also be an aqueous solution such as a saline solution described herein. If the water is mixed with other liquids or contains other components the resulting mixture or solution should in general be such that it does not significantly impact the swelling of the AGM in a negative way, e.g., by having high ionic strength and leaving salt in the AGM after dewatering that decreases the swelling forces.

The absorbent gelling material in step a) is preferably in solid form, preferably in the form of particles, fibers, spheres, flakes, cubes, disks, platelets and/or agglomerates.

In the first embodiment, the absorbent gelling material that is being coated has preferably a CCRC value of at least 30 g/g, preferably at least 40 g/g, more preferably at least 50 g/g, and further even more preferably is, in the first and second embodiment, that the absorbent gelling material has a CCRC value of at least 80 g/g, or even at least 100 g/g.

Preferred is also that the absorbent gelling material has a very low amount of extractables, as described below in more detail.

Preferably the absorbent gelling material in step a) comprises less than 20 g/g, and in some preferred embodiments even less than about 10 g/g of liquid, e.g., water.

Preferred is that in the second embodiment, the absorbent gelling material comprises the liquid, e.g., water, at a level of 1.0 g/g to about 20 g/g, preferably from 2 g/g or even 4 g/g to about 20 g/g or even 10 g/g (liquid weight/weight of the absorbent material).

The treatment agent may for example comprise a cross-linking agent, so that in the process, the surface of the absorbent gelling material is at least partially surface-cross-linked, and optionally also cross-linked internally, by said agent. The treatment agent may also comprise a coating agent, so that in the process the surface of the absorbent gelling material is coated, for example with a polymeric elastomeric material, preferably having an elongation to break (=wet-extensibility at break) in the wet state of at least 200%, preferably at least 500%, more preferably at least 1000% or even at least 1100%, and/or having a tensile stress at break in the wet state of at least 1 MPa, preferably at least 3 MPa and most preferably at least 5 MPa.

The invention also relates to surface-treated absorbent gelling material obtainable by any of the processes of the invention.

Preferably, this material, obtainable by the processes of the invention, has as surface treatment a coating or shell that is wrinkled.

The invention also relates to absorbent structures and articles comprising the surface-treated absorbent gelling material herein.

### DETAILED DESCRIPTION

### Absorbent Gelling Material

The absorbent gelling material may be any absorbent gelling material known in the art, often referred to as AGM or SAP (super absorbent polymer).

The absorbent gelling material, hereinafter referred to as AGM, has typically a CCRC value (as determined by the method described herein) of at least 30 g/g, or even at least 60 g/g (as is the case in the second embodiment of the invention), or even at least 80 g/g or even 100 g/g.

The AGM comprises a certain amount of water at the moment of the surface treatment, typically in the amounts specified above.

Preferred AGM useful to prepare the AGM of step a) of the process of the invention, has a free swell rate (FSR) of at least 0.05 g/g/sec, preferably at least 0.1 g/g/sec, and more preferably at least 0.2 g/g/sec. Typically, it is preferred that the AGM of step a) of the process of the invention will have a free swell rate of less than 2 g/g/sec.

It is preferred herein that the AGM is in solid form, prior to forming the water-containing AGM of step a) of the process, have a specific surface area of at least 0.01 m² per gram, preferably at least 0.1 m² per gram, and more preferable at least 0.25 m² per gram in accordance with the specific surface evaluation method as defined e.g., in “Modern Super Absorbent Technology” by F. L. Buchholz and A. T. Graham, published by Wiley VCH, New York, 1998.

Also, the resulting surface treated AGM is preferably solid; preferably the AGM and/or the surface treated AGM is in the form of particles, flakes, fibres, agglomerated particles; most preferably the surface treated Agm is coated AGM that are particles having a mass median particle size similar to the AGM, with only a light increase in caliper due to the coating caliper, as specified herein.

The AGM and surface treated AGM may be in the form of particles with a particle size preferably in the range of 10 μm to about 2 mm, or even to 1 mm, preferable in the range of 40 μm to 1 mm.

In one embodiment of the invention the AGM and surface treated AGM may have particle sizes between 10 μm and 1200 μm or even between 50 μm and 800 μm and a mass median particle size between 100 and 600 μm.

In addition, or in another embodiment of the invention, the AGM and surface treated AGM comprises particles that are essentially spherical.

In yet another preferred embodiment of the invention the water swellable material of the invention has a relatively narrow range of particle sizes with the majority of particles having a particle size between 50 μm and 800 μm, preferably between 100 μm and 500 μm, and more preferably between 200 μm and 500 μm.

The AGM is preferably a polymeric material, which is preferably substantially water-insoluble.

These polymers may in step a) already be (lightly) crosslinked, preferably lightly crosslinked hydrophilic polymers. While these polymers may in general be non-ionic, cationic, zwitterionic, or anionic, the preferred polymers are cationic or anionic. Especially preferred are acid polymers, which contain a multiplicity of acid functional groups such as carboxylic acid groups, or salts thereof, preferably sodium salts. Examples of acid polymers suitable for use herein include those which are prepared from polymerizable, acid-containing monomers, or monomers containing functional groups which can be converted to acid groups after polymerization. Thus, such monomers include olefinically unsaturated carboxylic acids and anhydrides, and mixtures thereof. The acid polymers can also comprise polymers that are not prepared from olefinically unsaturated monomers.

Examples of such polymers also include polysaccharide-based polymers such as carboxymethyl starch and carboxymethyl cellulose, and poly(amino acid) based polymers such as poly(aspartic acid). For a description of poly(amino acid) absorbent polymers, see, for example, U.S. Pat. No. 5,247,068, issued Sep. 21, 1993 to Donachy et al.

Some non-acid monomers can also be included, usually in minor amounts, in preparing the absorbent polymers herein. Such non-acid monomers can include, for example, monomers containing the following types of functional groups: carboxylate or sulfonate esters, hydroxyl groups, amide-groups, amino groups, nitrile groups, quaternary ammonium salt groups, and aryl groups (e.g., phenyl groups, such as those derived from styrene monomer). Other optional non-acid monomers include unsaturated hydrocarbons such as ethylene, propylene, 1-butene, butadiene, and isoprene. These non-acid monomers are well-known materials and are described in greater detail, for example, in U.S. Pat. No. 4,076,663 (Masuda et al.), issued Feb. 28, 1978, and in U.S. Pat. No. 4,062,817 (Westerman), issued Dec. 13, 1977.

Olefinically unsaturated carboxylic acid and anhydride monomers useful herein include the acrylic acids typified by acrylic acid itself, methacrylic acid, α-chloroacrylic acid, a-cyanoacrylic acid, β-methylacrylic acid (crotonic acid), α-phenylacrylic acid, β-acryloxypropionic acid, sorbic acid, α-chlorosorbic acid, angelic acid, cinnamic acid, p-chlorocinnamic acid, β-stearylacrylic acid, itaconic acid, citroconic acid, mesaconic acid, glutaconic acid, aconitic acid, maleic acid, fumaric acid, tricarboxyethylene, and maleic anhydride.

Preferred absorbent gelling polymers contain carboxyl groups. These polymers include hydrolyzed starch-acrylonitrile graft copolymers, partially neutralized hydrolyzed starch-acrylonitrile graft copolymers, starch-acrylic acid graft copolymers, partially neutralized starch-acrylic acid graft copolymers, hydrolyzed vinyl acetate-acrylic ester copolymers, hydrolyzed acrylonitrile or acrylamide copolymers, slightly network crosslinked polymers of any of the foregoing copolymers, polyacrylic acid, and slightly network crosslinked polymers of polyacrylic acid. These polymers can be used either solely or in the form of a mixture of two or more different polymers. Examples of these polymer materials are disclosed in U.S. Pat. No. 3,661,875, U.S. Pat. No. 4,076,663, U.S. Pat. No. 4,093,776, U.S. Pat. No. 4,666,983, and U.S. Pat. No. 4,734,478.

Most preferred polymer materials used for making the AGM for step a) of the process herein are polyacrylates/acrylic acids and derivatives thereof, preferably (slightly) network crosslinked polymers partially neutralized polyacrylic acids and/or -starch derivatives thereof.

Preferred may be that partially neutralized polymeric acrylic acid is used for the process herein.

Most preferably, the polymers comprise from about 50-95% (mol percentage), preferably about 75% neutralized, (slightly) network crosslinked, polyacrylic acid (i.e., poly (sodium acrylate/acrylic acid)). Network crosslinking renders the polymer substantially water-insoluble and, in part, determines the absorptive capacity and extractable polymer content characteristics of the absorbent polymers. Processes for network crosslinking these polymers and typical network crosslinking agents are described in greater detail in U.S. Pat. No. 4,076,663.

Any known crosslinking technique may be used to form cross-linked AGM useful in step a) herein. Typical processes for producing these polymers are described in U.S. Reissue Pat. 32,649 (Brandt et al.), issued Apr. 19, 1988, U.S. Pat. No. 4,666,983 (Tsubakimoto et al.), issued May 19, 1987, and U.S. Pat. No. 4,625,001 (Tsubakimoto et al.), issued Nov. 25, 1986. Crosslinking can be affected during polymerization by incorporation of suitable crosslinking monomers. Alternatively, the polymers can be crosslinked after polymerization by reaction with a suitable reactive crosslinking agent.

It may be preferred that the AGM of step a) is already surface-crosslinked, prior to the surface-treatment step b) of the process herein. But, it should be noted that in step a) of the process herein, non-cross-linked absorbent gelling material may be used and that in step a), or subsequent to step a) (surface) cross-linking may take place, as well as (or even at the same time as) a surface treatment step (other than cross-linking or surface crosslinking, e.g., a coating step as described herein).

In another embodiment, the surface-treatment step b) of the process herein may be a surface-cross-linking process step, to treat the surface of the AGM of step a) of the process such that it becomes surface-cross-linked, such as by methods described herein below.

It may also be preferred that the surface-treated AGM is post treated such that surface-cross-linking takes place, e.g., a curing step whereby (surface) cross-linking agents are added.

While the AGM is preferably of one type (i.e., homogeneous), mixtures of absorbent gelling materials (polymers) can also be used in the present invention. For example, mixtures of starch-acrylic acid graft copolymers and slightly network crosslinked polymers of polyacrylic acid can be used in the present invention. Mixtures of (coated) polymers with different physical properties, and optionally also different chemical properties, could also be used, e.g., different mean particle size, absorbent capacity, absorbent speed, SFC value) such as for example disclosed in U.S. Pat. No. 5,714,156 which is incorporated herein by reference.

In absorbent structures or articles according to the present invention, there can be used one and the same surface-treated AGM, and thus AGM, throughout the total structure, or there can be different types or materials in different parts of the structure. (Also, as described below, the surface treated AGM can have the same concentration throughout the structure or article, or can be at varying concentrations distributed there through; e.g., there can be a gradient in the amount of surface-treated AGM per volume unit, type, or property within the structure or article.)

### Treatment Agents

The water-containing AGM of step a) is treated with a treatment agent, to thereby treat the surface of the water-containing AGM.

The treatment agent may for example be a (surface) cross-linking agent, which cross-links at least part of the polymers present on the surface of the water-containing AGM.

The water-containing AGM may also have internal crosslinking; however, after the surface treatment with the (surface) cross-linking agent, the surface of the water-containing AGM has a higher level of crosslinking than in the interior. This can be visualized by methods known in the art and for example described below.

Depending on size, shape, porosity as well as functional considerations of the AGM, the degree and gradient of surface crosslinking can vary. For particulate hydrogel-forming absorbent polymers, surface crosslinking can vary with particle size, porosity, etc.

Suitable crosslinking agents for this purpose are compounds which contain at least two groups which can form covalent bonds with e.g., the carboxyl groups of the water absorbent polymer. Suitable compounds are, for example, di- or polyglycidyl compounds, such as diglycidyl phosphonates, alkoxysilyl compounds, polyariziridines, polyamines or polyamidoamines, it also being possible for the compounds mentioned to be used as mixtures with one another. Especially useful surface crosslinking agents are for example alkylene (e.g., ethylene) glycoldiglycidylether. Any surface-crosslinking agents and conditions known in the art may be used, for example as described in U.S. Pat. No. 4,541,871 (Obayashi), issued Sep. 17, 1985; published PCT application WO92/16565 (Stanley), published Oct. 1, 1992, published PCT application WO90/08789 (Tai), published Aug. 9, 1990; published PCT application WO93/05080 (Stanley), published Mar. 18, 1993; U.S. Pat. No. 4,824,901 (Alexander), issued Apr. 25, 1989; U.S. Pat. No. 4,789,861 (Johnson), issued Jan. 17, 1989; U.S. Pat. No. 4,587,308 (Makita), issued May 6, 1986; U.S. Pat. No. 4,734,478 (Tsubakimoto), issued Mar. 29, 1988; U.S. Pat. No. 5,164,459 (Kimura et al.), issued Nov. 17, 1992; published German patent application 4,020,780 (Dahmen), published Aug. 29, 1991; U.S. Pat. No. 5,140,076 (Harada); U.S. Pat. No. 6,376,618 B1, U.S. Pat. No. 6,391,451 and U.S. Pat. No. 6,239,230 (Mitchell); U.S. Pat. No. 6,150,469 (Harada); and published European patent application 509,708 (Gartner), published Oct. 21, 1992.

In a preferred embodiment of the present invention, the (surface) crosslinking treatment agents used in step b) have a low diffusion rate into the water swellable polymer that they are coated on. This is to ensure that they stay in the vicinity of the surface and not increase the overall degree of internal crosslinking sufficiently. This may be achieved by mixing the surface crosslinking agent in a solvent that is decreasing the penetration rate such as propane diol.

The surface treatment step b) may also involve polymerisation onto the surface of the water-containing AGM of step a), so-called interfacial polymerisation.

Interfacial polymerisation is typically done by using two monomers or low molecular weight polymers whereby the first one—compound A—is water soluble and the other one—compound B—is not water soluble but soluble in a solvent that is not miscible with water. The first compound A is the mixed with water and the compound B with said solvent as for example cylcohexane. The AGM or water-containing AGM is suspended in said solvent and water is added to achieve the target water content before surface treating the water-containing AGM. In addition the compound A is added now or concurrently with the water such as to allow absorption onto the surface of the water swellable polymer. Now the compound B is added to the solvent and the polymerisation is happening at the solvent/water interface of the water swellable polymer under suitable reaction conditions such as appropriate temperature and optionally a catalyst.

Suitable compounds A are selected which are preferably not undergoing further polymerisation without the presence of compound B but which are copolymerising in the presence of B, and vice versa. Example for compound A are polyethyleneimine, and for compound B isophthaloyl dichloride.

In a highly preferred embodiment the treatment agent comprises a coating agent. Any coating agent known in the art for coating particles, e.g., such as AGM, may be used.

The coating agent may preferably be hydrophilic (as described below in more detail).

The coating is preferably not water-soluble, once on the AGM.

Preferred coating agents are such that they do not reduce the surface tension in water by more than 10%, or even by no more than 5%, as described in co-pending application EP03014926.4.

It may be preferred that the coating agent is applied in the form of particles or a dispersion of particles (that are not film-forming) which are very fine, e.g., having a mass median particle size of 0.1 to 150 microns, preferably 1 to 100 microns or in certain embodiments even from 1 to 50 microns.

In one preferred embodiment, the coating agent comprises a compound that has at least two polar groups, preferably at least one cationic group (preferably an amine group, guanidine group), most preferably at least one cationic and at least one anionic polar group.

Namely, it has been found that especially organic compounds that have a cationic group may be or provide permanent coating agent, as described above, resulting in a low or no surface tension reduction in use, when absorbing liquid (such as blood, urine).

Thereto, preferred coating agents comprise one or more of the following group: N-(2-Acetamido)-2-aminoethansulfonic-acid, N-(2-Acetamido)-imino-di-acetic-acid, N-acetyl-glycin, β-Alanin, Aluminum-hydroxy-acetat, N-Amidino-glycin, 2-Amino-ethyl-hydrogenphosphate, 2-Amino-ethyl-hydrogensulfate, Amino-methan-sulfonic-acid, Maleinic-acid, Arginin, Asparaginic-acid, Butane-di-acid, Bis(1-aminoguanidinium)-sulfat, 2-Oxo-propionic-acid, Tri-Calcium-di-citrat, Calciumgluconat, Calcium-saccharat, Calcium-Titriplex®, Carnitin, Cellobiose, Citrullin, Creatin, Dimethylaminoacetic acid, THAM-1,2-disulfonic-acid, Ethylendiammoniumsulfate, Fructose, Fumaric-acid, Galactose, Glucosamine, Gluconic-acid, Glutamine, 2-Amino-glutaric-acid, Glutaric-acid, Glycin, Glycylglycin, Imino-di-acetic-acid, Magnesium-glycerophosphate, Oxalicacid, Tetrahydroxy-adipinic-acid, Taurin, N-Methyl-taurin, Tris-(hydroxymethyl)-aminomethan, N-(Tris-(hydroxymethyl)-methyl)-2-aminoethansulfonicacid.

Highly preferred may be that the coating agent comprises a film forming polymeric material.

Preferred coating agents comprise a wet-extensible material, preferably a polymeric wet-extensible film-forming material.

Preferred wet-extensible (film-forming) materials herein have a wet extensibility at break of at least 200%, or even at least 500% or even at least 800% or even at least 1100% or even at least 1200% or even at least 1600% or even at least 2000% or even at least 2500%, as defined by the wet-extensibility method set out herein.

The wet-extensible material is preferably an elastomeric polymer. It is believed that the elastomeric polymeric materials provide a return force when being extended and thus enable the coating (shell/layer) to provide tangential forces around the water swellable polymer, and thus will thereby act like the elastic membrane of a balloon and thus aid in providing a resistance to deformation for the water swellable material of the invention.

It should be understood for the purpose of the invention that, upon swelling of the AGM, the wet-extensible material and the coating agent typically extend (in wet state) their surface area, without (substantially) expanding in volume by liquid absorption. The wet-extensible polymeric material and the coating agent are thus typically substantially non-water-swelling. Preferred may be that the wet-extensible material and or coating agent is non-water-swellable, as for example may be determined by the method set out herein below. The inventors have found that materials that are substantially not swellable in water have typically a higher wet extensibility compared to materials that swell significantly in water.

This means in practice that the wet-extensible material and the preferred coating agent have preferably a water-swelling capacity of less than 1 g/g, or even less than 0.5 g/g, or even less than 0.2 g/g or even less than 0.1 g/g, as may be determined by the ‘Method of determining water swellability of a polymeric material’ as set out below.

The wet-extensible material (and preferably the coating agent as a whole) has a tensile stress at break in the wet state of at least 1 MPa, or even at least 3 MPa and more preferably at least 5 MPa. This can be determined by the Wet Tensile test method, described below.

Particularly preferred wet extensible materials for use in the coating agent herein are materials that have an Average Wet Elastic Modulus at Break of at least about 0.1 MPa, preferably at least about 0.2 MPa, more preferably at least about 0.5 MPa, and most preferably of at least about 1 MPa. Typically, the wet extensible materials for use in the coating agent will have an Average Wet Elastic Modulus at Break of less than 10 MPa, and preferably at least MPa. The Average Wet Elastic Modulus at Break for wet extensible materials may be determined by the Wet Tensile Stress Test method as described further below.

It should be noted that the inventors found that there is in general no or little correlation between the wet-extensibility or elongation to break in the dry and in the wet state, and materials with similar wet-extensibility to break in the dry state may have very different wet-extensibility or elongation to break in the wet state; for example a film of the commercially available styrene-butadiene elastomeric polymer, Genflo 3056 available from OMNOVA (address see below) has a extensibility or elongation in the dry state of 1520%, but in the wet state of only 80% (but after curing for 2 hours at 140 Celsius it has 1280%). This material would thus not be useful in the present invention, unless cure as described herein. However, other latex materials have a suitable wet-extensibility (per se or after curing), which may even be higher than their extensibility in the dry state (such as the commercially available GenFlo 3088 by OMNOVA, after curing).

Preferred wet-extensible, preferably polymeric elastomeric, materials herein have a glass transition temperature Tg of below 35° C., preferably less than 20° C., more preferably less than 0° C., and most preferably between 0° C. and −60° C. (i.e., Tg's before curing, as described herein as optional process step).

The coating agent is preferably such that the resulting coating on the water-swellable polymers herein is water-permeable, but not water-soluble and, preferably not water-dispersible. The water permeability of the coating should be high enough such that the coated AGM has a sufficiently high free swell rate as defined above, preferably a free swell rate (FSR) of at least 0.05 g/g/sec, preferably at least 0.1 g/g/sec, and more preferably at least 0.2 g/g/sec.

Preferred wet-extensible elastomeric, polymeric materials herein include natural or synthetic elastomeric polymeric materials, preferably elastomeric polymeric material selected from the group of natural rubber, synthetic rubber and thermoplastic elastomeric polymers that are elastic at 35° C., or below any of the temperatures above.

Preferred are polymers that form elastomeric films that are wet extensible but that are not tacky or sticky in the dry state. Especially preferred are coating agents that are not tacky or sticky in the dry state but are sticky or tacky in the wet state.

The wet extensible polymers useful in coating agents of the present invention are preferably polymers that can be self-crosslinking i.e. form covalent crosslinks in the polymer network to make it thermoset. Alternatively, crosslinking agents may be added to the wet-extensible polymers to cause crosslinking after activation, e.g., with high temperature, described hereinafter under the discussion of the curing step c).

While it is generally preferred to apply the coating agents in such a way in the process that the wet-extensible polymers thereof have already been made by a polymerization reaction, this does not generally need to be the case and the coating agent may also be formed from precursor materials that are polymerizable and are polymerized to form the wet-extensible polymers herein, during the process of making the coated AGM (e.g., step b,) such as for example by interfacial polymerization on the surface of the water swellable polymers or by depositing the precursor polymerizable materials via Chemical Vapor Deposition (CVD) as it is known in the art and subsequently polymerizing them to form the wet-extensible material of the coating agent.

In a preferred embodiment, the wet extensible polymers useful in coating agents of the present invention may be reactive, preferably thereto being a carboxylated wet-extensible polymeric (elastomeric) material. Especially preferred coating agents comprise polymers, co-polymers, and/or blockcopolymers of ethylene, vinyl compounds (e.g., styrene, vinylacetate, vinylformamide), polyunsaturated monomers (e.g., butadiene, isoprene), as well as polyurethanes, polyethers, polydimethylsiloxanes, proteins, which may optionally be grafted and/or be partially modified with chemical substituents (e.g., hydroxyl groups or carboxylates).

Highly preferred materials useful in the coating agent herein are commercially available wet-extensible, elastomeric latex materials, such for example from the Hystretch, Vinamul, Dur-O-Set Elite, GenFlo and AcryGen series, in particular Hystretch V43, Hystretch V60, Hystretch V23, Vinamul 3301, Vinamule Dur-O-Set Elite Ultra, Vinamul Dur-O-Set Elite 21, Rovene 4151, Rovene 5550, GenFlo 3075, GenFlo 3088, GenFlo 3000, Suncryl CP-75, AcryGen DV242DX, AcryGen 1900 D.

Hystretch is a trademark of Noveon Inc., 9911 Brecksville Road, Cleveland, Ohio 44141-3247, USA. Vinamul and Dur-O-Set Elite are trademarks of Vinamul Polymers, De Asselen Kuil 20, 6161 RD Geleen, NL. Rovene is a trademark of Mallard Creek Polymers, 14700 Mallard Creek Road, Charlotte, N.C. 28262, USA. GenFlo, AcryGen and Suncryl are trademarks of Omnova Solutions Inc., 2990 Gilchrist Road, Akron, Ohio 44305-4418, USA.

Particularly preferred coating agents comprise Surface Hydrophilic Elastic Latexes (SHEL) as described for example in U.S. Pat. No. 4,734,445; U.S. Pat. No. 4,835,211, U.S. Pat. No. 4,785,030; EP 0 799 258 B1 all of which are incorporated herein by reference. These particularly preferred SHEL materials typically comprise: (1) a liquid phase selected from the group consisting of water, water-miscible solvents and mixtures thereof; and (2) an effective amount of latex particles dispersed in the liquid phase. These particles comprise an elastomeric hydrophobic core and an outer hydrophilic shell integral with the elastomeric core. The hydrophilic shell of the particles ultimately translates into the hydrophilic surface of films formed therefrom, and also advantageously stabilizes the particles as colloids in the liquid phase. The shell comprises hydrophilic moieties -X which are attached to the core via linking group L-. When the liquid phase is removed, the particles form an elastomeric film having a substantially permanent hydrophilic surface. The SHEL compositions have the desirable property of forming elastomeric films having a hydrophilic surface and surface hydrophilicity, combined with other properties such as flexibility, elasticity and strength.

Other examples of wet extensible materials include elastomeric materials having wet-extensibility properties like VFE-CD, available from Tredegar, and L-86, available from Fulflex (Limerick, Ireland), or preferably L-89, available from Fulflex, or more preferred are of course one or more of these materials itself.

Also mixtures of wet-extensible materials may be present in the coating agent.

In addition to the wet-extensible material, the coating agent may also comprise other components, such as the following.

Preferred polymeric elastomeric materials for use in the coating agent herein are strain hardening and/or strain crystallizing. While there are some elastomeric polymers that are strain crystallizing, this property can also be imparted by the addition or blending of materials into the polymer. Hereto, the coating agent may comprise additional components that increase the strain hardening and/or strain crystallization of the wet-extensible material, such as organic or inorganic fillers. Nonlimiting examples of inorganic fillers include various water-insoluble salts, and other (preferably nanoparticulate) materials such as for example chemically modified silica, also called active or semi-active silica that are for example available as fillers for synthetic rubbers. Examples for such fillers are UltraSil VN3, UltraSil VN3P, UltraSil VN2P, and UltraSil 7000GR available from Degussa AG, Weiβfrauenstraβe 9, D-60287 Frankfurt am Main, Germany.

The coating agent and/or the wet-extensible material are preferably hydrophilic and in particular surface hydrophilic. The surface hydrophilicity may be determined by methods known to those skilled in the art. In a preferred execution, the hydrophilic coating agents or wet-extensible materials are materials that are wetted by the liquid that is to be absorbed (0.9% saline; urine). They may be characterized by a contact angle that is less than 90 degrees. Contact angles can for example be measured with the Video-based contact angle measurement device, Krüss G10-G1041, available from Kruess, Germany or by other methods known in the art.

Preferred is that the resulting surface treated AGM is also hydrophilic. The hydrophilicity of AGM and surface treated AGM may be measured as described in co-pending U.S. patent application Ser. No. 10/881,090.

If the wet-extensible material or the coating agent itself is not hydrophilic, it can be made hydrophilic for example by treating it with surfactants, plasma coating, plasma polymerization, or other hydrophilic surface treatments as known to those skilled in the art.

Surfactants are especially useful in the surface treatment agent, e.g., the coating composition as wetting agents to facilitate the dispersion of the coating agent onto the substrate. Surfactants are preferably included when the coating composition is used to treat a hydrophobic substrate.

The surfactant may be added directly to the process, e.g., in step b) or it may be added to the surface-treatment agent or in particular the coating agent. When a surfactant is used in the coating agent, it may be added at an effective amount to provide or facilitate application of the coating composition. Surfactant, when present, is typically employed in the agent at levels of from about 0.0001% to about 60%, preferably from about 0.001% to about 35%, and more preferably from about 0.001% to about 25%, by weight of the surface treatment (e.g., coating) agent.

Suitable surfactants can be selected from the group including anionic surfactants, cationic surfactants, nonionic surfactants, amphoteric surfactants, ampholytic surfactants, zwitterionic surfactants and mixtures thereof. Nonlimiting examples of surfactants useful in the compositions of the present invention are disclosed in McCutcheon's, Detergents and Emulsifiers, North American edition (1986), published by Allured Publishing Corporation; McCutcheon's, Functional Materials, North American Edition (1992); U.S. Pat. Nos. 5,707,950 and 5,576,282; and U.S. Pat. No. 3,929,678, to Laughlin et al., issued Dec. 30, 1975. Nonlimiting examples of surfactants include nonionic and amphoteric surfactants such as the C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and the like. Another class of useful surfactants is silicone surfactants and/or silicones. They can be used alone and/or alternatively in combination with the alkyl ethoxylate surfactants described herein. Nonlimiting examples of silicone surfactants are the polyalkylene oxide polysiloxanes having a dimethyl polysiloxane hydrophobic moiety and one or more hydrophilic polyalkylene side chains, and having the general formula:
R¹—(CH₃)₂SiO—[(CH₃)₂SiO]ₐ-[(CH₃)(R¹)SiO]_{b}-Si(CH₃)₂-R¹
   wherein a+b are from about 1 to about 50, and each R¹ is the same or different and is selected from the group consisting of methyl and a poly(ethyleneoxide/propyleneoxide) copolymer group having the general formula: —(CH₂)ₙO(C₂H₄O)_{c}(C₃H₆O)_{d}R², wherein n is 3 or 4; total c (for all polyalkyleneoxy side groups) has a value of from 1 to about 100, alternatively from about 6 to about 100; total d is from 0 to about 14; alternatively d is 0; total c+d has a value of from about 5 to about 150, alternatively from about 9 to about 100 and each R² is the same or different and is selected from the group consisting of hydrogen, an alkyl having 1 to 4 carbon atoms, and an acetyl group, alternatively hydrogen and methyl group. Each polyalkylene oxide polysiloxane has at least one R¹ group being a poly(ethyleneoxide/propyleneoxide) copolymer group. Silicone superwetting agents are available from Dow Corning as silicone glycol copolymers (e.g., Q2-5211 and Q2-5212).

Alternatively, the surface treatment agent can be made hydrophilic with a hydrophilicity boosting compositions comprising a hydrophilicity-boosting amount of nanoparticles. By hydrophilicity boosting amount, it is intended that an amount of nanoparticles be present in the hydrophilicity boosting compositions, which is sufficient to make a substrate to which it is applied more hydrophilic. Such amounts are readily ascertained by one of ordinary skill in the art; it is based on many factors, including but not limited to, the substrate used, the nanoparticles used, the desired hydrophilicity of the resulting surface-treated AGM.

Nanoparticles are particles that have a primary particle size, that is diameter, which is of the order of magnitude of nanometers. That is, nanoparticles have a particle size ranging from about 1 to about 750 nanometers. Nanoparticles with particle sizes ranging from about 2 nm to about 750 nm can be economically produced. Non-limiting examples of particle size distributions of the nanoparticles are those that fall within the range from about 2 nm to less than about 750 nm, alternatively from about 2 nm to less than about 200 nm, and alternatively from about 2 nm to less than about 150 nm.

The particle size of the nanoparticles is the largest diameter of a nanoparticle and may be measured by any method known in the art.

The mean particle size of various types of nanoparticles may differ from the particle size of the nanoparticles particles. For example, a layered synthetic silicate can have a mean particle size of about 25 nanometers while its particle size distribution can generally vary between about 10 nm to about 40 nm. (It should be understood that the particle sizes that are described herein are for particles when they are dispersed in an aqueous medium and the mean particle size is based on the mean of the particle number distribution. Non-limiting examples of nanoparticles can include crystalline or amorphous particles with a particle size from about 2 to about 750 nanometers. Boehmite alumina can have an average particle size distribution from 2 to 750 nm.).

The hydrophilicity boosting composition may consist of the nanoparticles, and then the nanoparticles are directly added to the surface-treatment agent or to the process, e.g., in step b). Alternatively, the nanoparticles are present in a composition with other carrier ingredients, e.g., solvents or disperent liquids; in one preferred embodiment the nanoparticles are applied in step b) as a dispersion in a liquid. If the hydrophilicity boosting composition does not consist of the nanoparticles, but comprises other ingredients, then it is preferred that the nanoparticles are present in the hydrophilicity boosting compositions at levels of from about 0.0001% to about 50%, preferably from about 0.001% to about 20% or even to 15%, and more preferably from about 0.001% to about 10%, by weight of the composition.

Either organic or inorganic nanoparticles may be used in the hydrophilicity boosting composition; inorganic nanoparticles are preferred. Inorganic nanoparticles generally exist as oxides, silicates, carbonates and hydroxides. Some layered clay minerals and inorganic metal oxides can be examples of nanoparticles. The layered clay minerals suitable for use in the present invention include those in the geological classes of the smectites, the kaolins, the illites, the chlorites, the attapulgites and the mixed layer clays. Typical examples of specific clays belonging to these classes are the smectices, kaolins, illites, chlorites, attapulgites and mixed layer clays. Smectites, for example, include montmorillonite, bentonite, pyrophyllite, hectorite, saponite, sauconite, nontronite, talc, beidellite, volchonskoite. Kaolins include kaolinite, dickite, nacrite, antigorite, anauxite, halloysite, indellite and chrysotile. Illites include bravaisite, muscovite, paragonite, phlogopite and biotite and vermiculite. Chlorites include corrensite, penninite, donbassite, sudoite, pennine and clinochlore. Attapulgites include sepiolite and polygorskyte. Mixed layer clays include allevardite and vermiculitebiotite. Variants and isomorphic substitutions of these layered clay minerals offer unique applications.

Layered clay minerals may be either naturally occurring or synthetic. An example of one non-limiting embodiment of the coating composition uses natural or synthetic hectorites, montmorillonites and bentonites. Another embodiment uses the hectorites clays commercially available, and typical sources of commercial hectorites are the LAPONITEs ™ from Southern Clay Products, Inc., U.S.A; Veegum Pro and Veegum F from R. T. Vanderbilt, U.S.A.; and the Barasyms, Macaloids and Propaloids from Baroid Division, National Read Comp., U.S.A.

In one preferred embodiment of the present invention the nanoparticles comprise a synthetic hectorite a lithium magnesium silicate. One such suitable lithium magnesium silicate is LAPONITE™, which has the formula:
[Mg_{w}LiₓSi₈O₂₀OH_{4-y}F_{y]}^{z-}
   wherein w=3 to 6, x=0 to 3, y=0 to 4, z=12−2w−x, and the overall negative lattice charge is balanced by counter-ions; and wherein the counter-ions are selected from the group consisting of selected Na⁺, K⁺, NH₄⁺, Cs⁺, Li⁺, Mg⁺⁺, Ca⁺⁺, Ba⁺⁺, N(CH₃)₄⁺ and mixtures thereof. (If the LAPONITE™ is “modified” with a cationic organic compound, then the “counter-ion” could be viewed as being any cationic organic group (R⁺).)

Other suitable synthetic hectorites include, but are not limited to isomorphous substitutions of LAPONITE™, such as, LAPONITE B™, LAPONITE S™, LAPONITE XLS™, LAPONITE RD™, LAPONITE XLG™, and LAPONITE RDS™.

The nanoparticles may also be other inorganic materials, including inorganic oxides such as, but not limited to, titanium oxide silica, zirconium oxide, aluminum oxide, magnesium oxide and combinations thereof. Other suitable inorganic oxides include various other inorganic oxides of alumina and silica.

In one preferred embodiment of the present invention the nanoparticles comprise a Boehmite alumina ([Al(O)(OH)]ₙ) which is a water dispersible, inorganic metal oxide that can be prepared to have a variety of particle sizes or range of particle sizes, including a mean particle size distribution from about 2 nm to less than or equal to about 750 nm. For example, a boehmite alumina nanoparticle with a mean particle size distribution of around 25 nm under the trade name Disperal P2™ and a nanoparticle with a mean particle size distribution of around 140 nm under the trade name of Dispal® 14N4-25 are available from North American Sasol, Inc.

In one preferred embodiment of the present invention the nanoparticles are selected from the group consisting of titanium dioxide, Boehmite alumina, sodium magnesium lithium fluorosilicates and combinations thereof.

Use of mixtures of nanoparticles in the hydrophilicity boosting compositions is also within the scope of the present invention.

The hydrophilicity boosting compositions of the present invention may also include optional ingredients such as, a carrier, surfactant and other adjunct ingredients. Suitable carriers include liquids, solids and gases. One preferred carrier is water, which can be distilled, deionized, or tap water. Water is valuable due to its low cost, availability, safety, and compatibility.

Optionally, in addition to or in place of water, the carrier can comprise a low molecular weight organic solvent. Preferably, the solvent is highly soluble in water, e.g., ethanol, methanol, acetone, ethylene glycol, propanol, isopropanol, and the like, and mixtures thereof. Low molecular weight alcohols can reduce the surface tension of the nanoparticle dispersion to improve wettability of the substrate. This is particularly helpful when the substrate is hydrophobic. Low molecular weight alcohols can also help the treated substrate to dry faster. The optional water soluble low molecular weight solvent can be used at any suitable level. The carrier can comprise any suitable amount of the composition, including but not limited to from about 10% to about 99%, alternatively from about 30% to about 95%, by weight of the coating composition.

The hydrophilicity boosting composition may also comprise organic, e.g., latex nanoparticles, so-called nanolatexes. A “nanolatex”, as used herein, is a latex with a particle size less than or equal to about 750 nm. A “latex” is a dispersion of water-insoluble polymer particles that are usually spherical in shape. Nanolatexes may be formed by emulsion polymerization. “Emulsion polymerization” is a process in which monomers of the latex are dispersed in water using a surfactant to form a stable emulsion followed by polymerization. Particles are typically produced which can range in size from about 2 to about 600 nm. When the nanolatexes are wet-extensible materials, e.g., film-forming elastomeric polymers, then they are considered coating agents for the purpose of the invention, and not (part of) a hydrophilicity boosting composition.

The coating agent is preferably applied in fluid form, e.g., as melt (or so-called hotmelt), solution or dispersion. Preferred are water-based solutions or dispersions. In the context of this invention and as it is typically used in the art, the latexes referred herein are thus typically applied as water based dispersions of specific latex polymers, whereby the polymeric latex particles—typically of spherical shape—are suspended or dispersed (stable) in a water based liquid.

Thus, the coating agent may also comprise a solvent or dispersing liquid, such as water, THF (tetrahydrofurane), cyclohexane or other solvents or dispersing liquids that are able to dissolve or disperse the wet-extensible material (e.g., elastomeric polymer) and subsequently can be evaporated such as to form a (dry) coating shell or layer.

Preferably, the coating agent comprises from 0% to 95% by weight of a dispersing liquid or solvent, such as water. Preferred is that the coating agent comprises at least 10% by weight (of the coating agent) of the wet-extensible material, more preferably from 20% to 80% or even from 30% to 70%, the remaining percentage being said liquid and/or fillers/hydrophilicity aids, spreading aids etc, as described herein.

The inventors also found that the process of applying and subsequently treating the coating agent may be important in order to impart high extensibility in the wet state.

While some wet extensible material may already have high wet extensibility per se, (e.g., after a film is formed, for example from a dispersion, optionally followed by drying at medium temperatures that are high enough to cause the material to coalesce as known to those skilled in the art (and as is further explained for example in: Paul A. Steward et. al., Advances in Colloid and Interface Science 86 (2000) 195-267 “Literature Review of polymer latex film formation and properties”), it may be useful to apply a curing step as described herein to the material, e.g., conditions equivalent to achieve the level of curing as typically achieved when the material were to be submitted to 140 Celsius for 2 hours.

For example a film of Genflo3056 has a wet-extensibility at break of only 80% per se, but when submitted to the above curing step, it has a wet-extensibility at break of 1280%, while a film of GenFlo 3075 has a wet-extensibility of 1710% (and after curing only marginally more, 1730%).

In addition to providing the right mechanical properties in the wet state as it is outlined above, preferred coating agents of the invention preferably also have other desired properties such as high resistance against mechanical abrasion in order to survive processing into absorbent articles or structures, without significant deterioration of their properties. They also are preferably white and opaque and may in addition contain other materials such for example to control odor, release perfumes, and the like.

### Process of Surface-Treatment

The process of the invention involves the steps of a) obtaining absorbent gelling material with a certain amount of water absorbed therein and step b), treating the surface of this water-containing absorbent gelling material with a treatment agent and simultaneously with or subsequent to step b), removing at least a part of the water from said absorbent gelling material, to obtain surface-treated absorbent gelling material containing less than 50% of moisture.

Step a) can be done by any known method, allowing absorbent gelling material or precursor thereto, to absorb water or an aqueous solution. If precursors of absorbent gelling material are used, then not only water-absorption takes place in step a) but also formation of the AGM.

Step a) and b) may be done simultaneously, provided that the absorbent gelling material is allowed to absorb the required amount of water prior to completion of the surface treatment, since the surface treatment needs to take place on the surface of absorbent gelling material that contains water.

The conditions of the surface treatment step b) will mainly depend on the type of surface-treatment agent used in this step.

However, in a preferred process step b), or step a) and b) together, are done by contacting the absorbent gelling material with an (aqueous) solution or an (aqueous dispersion) of a treatment agent, e.g., by spraying such a solution or dispersion onto the AGM or by mixing the AGM into such a solution or dispersion, or for example by mixing or agglomerating the AGM of step a) and a treatment agent, (e.g., in the form of a melt, solution or dispersion thereof); by dip-coating the AGM of step a) in the coating agent (e.g., melt, dispersion or solution thereof). Examples of preferred coating processes are for example described in U.S. Pat. No. 5,840,329 and U.S. Pat. No. 6,387,495. For example, the AGM in step a) may in the form of a dispersion of AGM gel particles and the surface treatment step b) may then be done directly on these gel particles.

In a preferred process, the AGM may be suspended in a fluidized bed coater, such for example a Wurster coater or in another suitable mixer and water is sprayed onto the particles of the water swellable polymer to partially swell them to obtain the water-containing AGM of step a). This is then followed by the surface treatment process step b), for example directly in the same fluidized bed.

Other suitable mixers include for example twin drum mixers, so called “Zig-Zag” mixers, horizontally operating plough-share mixers, Lödige mixers, cone screw mixers, or perpendicularly cylindrical mixers having coaxially rotating blade.

For example, if the surface treatment comprises surface-cross-linking the AGM surface, then any surface-crosslinking agents and conditions known in the art may be used, for example as described above and in U.S. Pat. No. 4,541,871 (Obayashi), issued Sep. 17, 1985; published PCT application WO92/16565 (Stanley), published Oct. 1, 1992, published PCT application WO90/08789 (Tai), published Aug. 9, 1990; published PCT application WO93/05080 (Stanley), published Mar. 18, 1993; U.S. Pat. No. 4,824,901 (Alexander), issued Apr. 25, 1989; U.S. Pat. No. 4,789,861 (Johnson), issued Jan. 17, 1989; U.S. Pat. No. 4,587,308 (Makita), issued May 6, 1986; U.S. Pat. No. 4,734,478 (Tsubakimoto), issued Mar. 29, 1988; U.S. Pat. No. 5,164,459 (Kimura et al.), issued Nov. 17, 1992; published German patent application 4,020,780 (Dahmen), published Aug. 29, 1991; U.S. Pat. No. 5,140,076 (Harada); U.S. Pat. No. 6,376,618 B1, U.S. Pat. No. 6,391,451 and U.S. Pat. No. 6,239,230 (Mitchell); U.S. Pat. No. 6,150,469 (Harada); and published European patent application 509,708 (Gartner), published Oct. 21, 1992.

The treatment agent may also comprise polymerizable material and the surface of the AGM is then polymerised in step b), so that the treatment layer/or shell on the AGM is a polymer layer or shell. This can be done in the manner described above.

A highly preferred polymerisation process, involving interfacial polymerisation, is described below.

Highly preferred is that the treatment agent comprises a coating agent and the surface of the absorbent gelling material is coated with said coating agent, typically in the form of a coating layer or shell. The water-containing AGM of step a) may be dry-mixed with a treatment agent in step b), or it may be mixed in the coating agent, which is in the form of a melt or solution or dispersion thereof; it may also be done by spraying the coating agent or melt, solution or dispersion thereof, onto the AGM of step a).

In an alternative embodiment of the invention, step b) may be done by applying the coating agent in the form of a foam, preferably in the form of an open-cell foam, leading to a porous coating. In yet an alternative embodiment the coating step may be done by forming a fibrous network on the surface of AGM such as for example by applying the coating agent in the form of meltblown microfibers, such that an essentially connected coating is formed (as described herein).

If the coating agent is in the form of a dispersion or solution of a wet-extensible film-forming material, e.g., a latex dispersion, it may be further preferred to add processing aids such for example coalescing aids subsequently or prior to the coating step b) in order to aid a good film formation of the coating layer.

It may also be preferred that the coating agent comprises a (wet-extensible) polymeric material which is crosslinked in step b) or c), and hereto it may be preferred that additional components that facilitate the cross-linking are added in step a), b) or c).

In a highly preferred process, step a) and b) are performed simultaneously, namely involving the step of spraying AGM with, or immersing or mixing AGM in an aqueous dispersion of a elastomeric polymeric material, e.g., latex (as described herein), typically under thorough stirring. The AGM will absorb the water of the dispersion, and thereby, the coating elastomeric polymer is automatically ‘transferred’ to the surface of the water-containing AGM. The amount of AGM and the amount of water and coating polymer can be adjusted such that AGM can absorb about all water present in the dispersion and that when this is achieved, the coated, water-containing AGM, is in the form of a gel “powder”. The resulting coating is typically under zero strain/stress.

In step c), at least part of the water (and other liquids, if present) is removed from the surface-treated, water-containing AGM. This may be done by any known method, for example include drying methods such as radiation heating, oven heating, convection heating, or placing the coated polymers under vacuum and optionally increased temperature, azeotropic heating, and it may for example take place in conventional equipment used for drying, such as fluidized bed driers. It may be done under vacuum or under an inert gas, e.g., to avoid oxidation. Any temperature and any drying time may be used. For example, the drying step may be done at a temperature of 40-200° C., or even 60 to 140° C. or even 80-100° C., for any time, preferably at least 1 hour or even at least 2 hours or even at least 12 hours, or even up to 48 hours.

The resulting surface-treated AGM may also simultaneously or subsequently be cured, by methods known in the art. The curing step typically involves a step resulting in a further strengthened or more continuous or more completely circumscribing and/or connected layer/shell (coating). For example, during the curing step the treatment layer/shell may be annealed or cross-linked.

The drying step may be done simultaneous with the curing step. However, preferred may be that the drying step is a separate step, prior to the curing step.

Typically, such a curing step that is also a drying step has two main effects that are desired. Firstly, since the majority of the present liquid (e.g., water) will be removed from the coated water-swellable polymers through the coating layer during the drying or curing step, the coating will become water permeable, e.g., by forming “pores” in, the coating, which is useful for future absorption of liquid (urine) in use. Secondly, the coating itself coalesces to form a wet-extensible, preferably elastic film.

The curing step may be done by any known method. Typically, the curing step involves a heat treatment of the surface treated AGM; it may be done by for example radiation heating, oven heating, convection heating, or placing the coated polymers under vacuum and increased temperature, azeotropic heating, and it may for example take place in conventional equipment used for drying, such as fluidized bed driers.

Preferred may be that a vacuum is applied as well or that the curing or drying is done under an inert gas (to avoid oxidation).

Preferably, the heat treatment involves heating the coated water-swellable polymers at a temperature of at least 70° C., or even at least 80° C., or even at least 100° C., or even at least 120° C. or even at least 130° C. or even at least 140° C., and preferably for at least 5 minutes, or even for at least 10 minutes or even for at least 15 minutes, or even at least 30 minutes or even at least 1 hour or even at least 2 hours. Preferred is that the maximum temperature is up to 300° C., or even up to 250° C. or even up to 200° C.

This heat-treatment may be done once, or it may be repeated, for example the heat treatment may be repeated with different temperatures, for example first at a lower temperature, for example from 70° C. or 80° C. to 100° C., as described above, for example for at least 1 hour, and subsequently at a higher temperature, for example 120-140° C. or even up to 300° C., for at least 10 minutes, to invoke chemical reactions, such as further polymerising or cross-linking the wet-extensible polymers of the coating agent.

It is believed that during the slow (e.g., at least 30 minutes or even at least 1 hour) heat treatment curing step, a so-called annealing step takes place, whereby the boundaries of the particles in the surface-treatment are starting to vanish by inter polymer chain diffusion. This will break the “cell walls” of the particles on the surface and this will allow the formation of an entangled polymer network, which has been found to be very important for mechanical strength of the surface, in particular in the wet state. If the “cell walls” which are typically hydrophilic and represent a diffusion barrier for the polymer chains are not destroyed, then upon immersion in water they can act as wicking boundaries leading to partial de-coalescing of the film and thus significant weakening of the film. Preferably, the temperature of the annealing process step (which may be simultaneously with the drying step), must be high enough to induce mobility of the polymer chains to “break” the hydrophilic cell walls and the annealing process step time must be long enough in order to allow sufficient time for chain diffusion and entanglement.

Preferably, when the treatment agent comprises a film-forming agent or comprises a film forming wet-extensible material, the curing and/or drying temperature is typically above the minimum film forming temperature (MFFT) of the agent.

The resulting surface-treated AGM is preferably solid. Thereto, an additional process step is sometimes required, e.g., a so-called solidifying step, including for example a particle-forming step, as known in the art, including agglomeration, extrusion, grinding and optionally followed by sieving to obtain the required particle size distribution. This may be done prior to step c), simultaneously with step c) or after step c).

In the event that the AGM in step a) is formed from the polymer precursors as described herein, it is generally required that step a) or b) also involves addition of the required components to facilitate the polymerisation reaction and/or cross-linking reaction to form the required AGM.

The process may also involve addition of further processing aids in any of the steps, such as granulation aids, flow aids, drying aids. Any flow aids known in the art may be added (for example prior to or during the coating step, or preferably during the drying and/or annealing and/or cross-linking step (s), as discussed below), for example Aerosil 200, available from Degussa has been found to be a good flow aid.

Also, it may be useful to mechanically agitate the wet surface treated AGM during the drying step, such as by stirring.

Highly preferred may be that the process involves addition of a spreading aid or surfactant, which facilitates the formation of a treatment layer or shell in step b). Preferred spreading aiding surfactants are any of the surfactants described above.

### Resulting Surface-Treated Absorbent Gelling Material

The resulting surface treated AGM of the invention comprises after step c) preferably less than 50% by weight of water, more preferably less than 20% or even less than 10% or even less than 5% by weight. Preferably, the surface treated AGM prepared according to the present invention is dry; e.g., the surface treated AGM has a fluid content of 0.01% to 5% by weight of the material.

The water-content of the surface-treated AGM can for example be determined by the EDANA test number ERT 430.1-99 (February 1999) which involves drying the surface-treated AGM at 105 C for 3 hours and determining the moisture content by the weight loss of the surface-treated AGM after drying.

The surface-treated AGM of the invention is such that it swells and gells in, at least, water and typically also in other water-based liquids such as a 0.9% saline water solution, as described herein.

The surface-treated AGM of the invention comprises AGM that is surface-treated and it thus comprises a treatment layer or shell on its surface. The surface treatment layer or shell is preferably present at a level of 0.5% to 50% by weight of surface-treated AGM, more preferably from 1% to 30% by weight or even from 1% to 20% by weight or even from 2% to 15% by weight.

The resulting treatment layer or shell, e.g., coating, is preferably thin and/or preferably uniform; preferably it has an average thickness or caliper between 0.1 micron to 250 microns (microns=μm=micrometer), more preferably from 1 micron to 100 microns or in certain embodiments even from 1 micron to 50 microns or even to 20 microns, or even more preferably from 2 to 15 microns.

The treatment layer or shell, e.g., coating, is preferably uniform in caliper and shape. Preferably, the average caliper is such that the ratio of the smallest to the largest caliper is between 1:5 to 1:1, preferably 1:2 to 1:1.

The surface-treated AGM may also contain AGM that is not surface-treated. Preferably, the surface treated AGM is present at a level of at least 20% by weight (of the total of the surface-treated and untreated AGM), more preferably between 50% and 100% by weight or even from 80% to 100% by weight, and most preferably between 90 and 100% by weight.

The surface-treated AGM of the invention may also comprise other components, such as fillers, flowing aids, process aids, anti-caking agents, odor control agents, colouring agents, etc.

The surface-treated AGM is preferably solid, which includes gels, flakes, fibres, agglomerates, large blocks, granules and particles, spheres and other forms known in the art for SAP or AGM's described herein above.

In one embodiment of the invention the surface-treated AGM of the invention is in the form of free flowing particles with a mass median particle size between 50 μm and 800 μm.

In addition, or in another embodiment of the invention, the surface-treated AGM comprises particles that are essentially spherical.

In yet another preferred embodiment of the invention the surface treated AGM of the invention has a relatively narrow range of particle sizes with the majority of particles having a particle size between 50 μm and 600 μm, preferably between 100 μm and 500 μm, and more preferably between 200 μm and 500 μm.

The material of the invention is typically in the form of so-called core-shell particles, whereby the AGM is present in the internal structure or core and the treatment agent/layer forms a shell around the AGM. In one preferred embodiment of the invention, the treatment layer/shell is an essentially continuous coating layer or shell around the AGM (core), such as to exert tangential forces around the AGM in the core when the surface-treated AGM swells in liquid.

The treatment layers or shells are preferably highly water permeable such as to allow a fast penetration/absorption of liquid into the surface-treated AGM (into the core).

In another preferred embodiment of the invention (or as preferred feature of the permeable layer/shell in the paragraph above), the treatment layer or shell is porous and in the form of a network comprising pores for penetration of water, such as for example in the form of a fibrous network, that is connected and circumscribing the particle as defined above.

It is preferred that the treatment layer or shell is connected and more preferably that the treatment layer/shell is connected and completely circumscribing the AGM.

For the purpose of this invention, it is preferred that the treatment shell or layer is connected such that for each two points P1 and P2 that are in the treatment layer/shell, there is at least one continuous line that connects these points P1 and P2 and that completely lies within the coated shell.

Preferably a treatment layer or shell is completely circumscribing the water swellable polymer(s) such that for each point P3 positioned in the water swellable polymer (and thus not on or in the coating shell or layer) and for each point P4 outside the water swellable material, all continuous bands having a circular cross-section that connect P3 and P4 and that have a diameter of 500 μm, or preferably even only 100 μm, will intersect the coated shell. (A band is defined as a line with a circular cross-section.)

Preferred may be that the surface-treated AGM comprises two or more layers or shells of treatment agent(s), obtainable by treating the AGM twice or more with the same or a different treatment agent. For example, the coating or shell may be formed by two layers or coatings of coating agents comprising wet-extensible material, e.g., polymeric elastomeric material, as described herein, or it may have a first layer or shell of surface-crosslinked material and a second shell or layer of wet-extensible material.

Especially preferred surface-treated AGM made by the process of the invention have a high sorption capacity measured by the CCRC test outlined below.

Especially preferred surface-treated AGM made by the process of the invention have a high permeability for liquid such as can be measured by the SFC test disclosed in U.S. Pat. No. 5,599,335, U.S. Pat. No. 5,562,646 and U.S. Pat. No. 5,669,894 all of which are incorporated herein by reference.

In addition, especially preferred surface-treated AGM made by the process of the invention have a high wet porosity (i.e. once an amount of the surface-treated AGM of the invention is allowed to absorb a liquid, it forms a (hydro)gel or (hydro)gelbed, which has a certain wet porosity), in particular compared to the uncoated AGM, as can be measured by the PHL test disclosed in U.S. Pat. No. 5,562,646 which is incorporated herein by reference; (if the surface-treated AGM or AGM are to be tested at different pressures, the weight used in this test should be adjusted accordingly).

The use of the coating agent preferably increases the wet porosity of the surface-treated AGM herein, compared to the untreated AGM; preferably this increase is at least 50% or even at least 100%, or even at least 150% (compared to the uncoated AGM).

Most preferred surface-treated AGM made by the process of the invention have a high sorption capacity and a high permeability (SFC) and a high wet porosity.

### Preferred Absorbent Structures and Articles

The absorbent structure of one embodiment of the invention is typically for use in (disposable) absorbent articles, such as preferably interlabial products, sanitary napkins, panty liners, and preferably adult incontinent products, baby diapers, nappies and training pants.

These preferred absorbent articles typically comprise a liquid impervious (but preferably gas or water vapour pervious) backsheet, a fluid pervious topsheet joined to, or otherwise associated with the backsheet, and the absorbent structure according to the present invention positioned between the backsheet and the topsheet. Such articles are well known in the art and fully disclosed in various documents mentioned throughout the description, e.g., in EP 752 892.

Typically, the absorbent structure of the invention is that part of an absorbent article which serves to store the bodily fluid, e.g., the storage layer of an absorbent article. As known in the art, this may be in direct contact with an acquisition layer, or in one embodiment of the invention, it may form a unitary structure with an acquisition layer. In yet another embodiment of the invention the absorbent structure is an acquisition layer for use in an absorbent article.

The absorbent structure may comprise the surface treated AGM of the invention at any weight level or concentration, but preferably, in particular when the absorbent structure serves as a storage layer, or when the absorbent structure comprises a layer that serves as storage layer, the structure or layer comprises large amounts of the water-swellable material herein, compared to possible other components of the structure, i.e., preferably more than 50% or even more than 70% or even more than 80% or even more than 90% of the super absorbent material herein, by weight of the structure or (storage) layer thereof.

The surface treated AGM may be mixed with absorbent fibrous material, such as an airfelt material, which can provide a matrix for immobilization of the water-swellable material. However, preferably a relatively low amount of absorbent fibrous (cellulose) material is used in the absorbent structure. Thus, if the absorbent structure is a liquid storage layer or when the absorbent structure comprises one or more liquid storage layers, it may be preferred that said liquid structure or said liquid storage layer comprises large amounts of the super absorbent material herein and only very little or no absorbent (cellulose) fibres, e.g., preferably less than 40% weight of that layer, or even less than 20% by weight or even less than 10 weight % or even less than 5% by weight of absorbent fibrous (cellulose) material, and preferably more than 50% or even more than 70% or even more than 80% or even more than 90%by weight of the water-swellable material herein.

It should be noted that the articles or structures may also comprise non-surface treated AGM in addition to the surface treated AGM.

The absorbent structure may comprise a wrapping material, which wraps the portion comprising the surface-treated AGM a so-called core wrap material. In one preferred embodiment the core wrap material comprises a top layer and a bottom layer, being furthest away from the skin of the user. The core wrap material, the top layer or the bottom layer can be provided from a non-woven material. One preferred material is a so-called SMS material, comprising a spunbonded, a melt-blown and a further spunbonded layer. Highly preferred are permanently hydrophilic non-wovens, and in particular nonwovens with durably hydrophilic coatings. An alternative preferred material comprises a SMMS-structure. The top layer and the bottom layer may be provided from two or more separate sheets of materials or they may be alternatively provided from a unitary sheet of material

Preferred non-woven materials are provided from synthetic fibers, such as PE, PET and most preferably PP. As the polymers used for nonwoven production are inherently hydrophobic, they are preferably coated with hydrophilic coatings, e.g., coated with nanoparticles, as known in the art.

Notably, permanently hydrophilic non-wovens are also useful in other parts of an absorbent article, for example as or in the topsheet.

In a preferred embodiment of the present invention the absorbent structure comprises a wrapping material, the surface-treated AGM, described herein, and a thermoplastic material and/or a layer of adhesive, which may be a (non-absorbing) fibrous layer of adhesive.

Preferred absorbent structures can for example be made as follows:
a) providing a substrate material that can serve as a wrapping material;
b) depositing surface-treated AGM onto a first surface of the substrate material, preferably in a pattern comprising at least one zone which is substantially free of surface-treated AGM and the pattern comprising at least one zone comprising the surface-treated AGM, preferably such that opening are formed between the zones with the surface-treated AGM;
c) depositing a thermoplastic material onto the first surface of the substrate material and the surface-treated AGM, such that portions of the thermoplastic material are in direct contact with the first surface of the substrate and portions of the thermoplastic material are in direct contact with the surface-treated AGM;
d) and then typically closing the above by folding the substrate material over, or by placing another substrate matter over the above.

Preferred disposable absorbent article herein are sanitary napkins, panty liners, adult incontinence products and infant diapers or training or pull-on pants, whereby articles which serve to absorb urine, e.g., adult incontinence products, diapers and training or pull-on pants are most preferred articles herein.

Preferred articles herein have a topsheet and a backsheet, which each have a front region, back region and crotch region, positioned therein between. The absorbent structure of the invention is typically positioned in between the topsheet and backsheet. Preferred backsheets are vapour pervious but liquid impervious. Preferred topsheet materials are at least partially hydrophilic; preferred are also so-called apertured topsheets. Preferred may be that the topsheet comprises a skin care composition, e.g., a lotion.

A preferred diaper or training pants herein has a front waist band and a back waist band, whereby the front waist band and back waist band each have a first end portion and a second end portions and a middle portion located between the end portions, and whereby preferably the end portions comprise each a fastening system, to fasten the front waist band to the rear waist band or whereby preferably the end portions are connected to one another, and whereby the middle portion of the back waist band and/or the back region of the backsheet and/or the crotch region of the backsheet comprises a landing member, preferably the landing member comprising second engaging elements selected from loops, hooks, slots, slits, buttons, magnets. Most preferred are hooks, adhesive or cohesive second engaging elements. Preferred may be that the engaging elements on the article, or preferably diaper are provided with a means to ensure they are only engage able at certain moments, for example, they may be covered by a removable tab, which is removed when the engaging elements are to be engaged and may be re-closed when engagement is no longer needed, as described above.

Preferred diapers and training pants herein have one or more sets of leg elastics and/or barrier leg cuffs, as known in the art.

Preferred may also be that the topsheet has a large opening, preferably with elastication means along the length thereof, where through waist material can pass into a void space above the absorbent structure, and which ensures it is isolated in this void space, away from the wearer's skin.

Preparation of AGM that is especially useful to prepare the water-containing AGM of step a) of the invention.

### EXAMPLE 1.1

### Process for Preparation of Spherical AGM Particles

Spherical AGM polymer particles may be obtained by UMSICHT (Fraunhofer Institut Umwelt-, Sicherheits-, Energietechnik, Oberhausen, Germany), or made by following the adapted procedure below:

40 g glacial acrylic acid (AA) is placed into a beaker, and 1712 mg MethyleneBisAcrylAmide (MBAA ) is dissolved in the acid. Separately, 13.224 g solid NaOH is dissolved in 58.228 g water and cooled. The NaOH solution is then slowly added to the acrylic acid, and the resulting solution is chilled to 4-10° C.

In a second beaker, 400 mg ammoniumperoxodisulfate (APS) and 400 mg sodiummetabisulfite are mixed and dissolved in 99.2 ml water. This solution is also chilled to 4-10° C.

With the use of two equal peristaltic pumps, both solutions are combined and pumped at equal rates through a short static mixer unit, after which they are dropped as individual droplets into 60-80° C. hot silicone oil (Roth M 50, cat. # 4212.2) which is in a heated, about 2 m long, glass tube. The pump rate is adjusted such that individual droplets sink through the oil in the tube, while also avoiding premature polymerization in the mixer unit. The polymerization proceeds during the descent of the droplets through the oil, and particles (gelled polymer droplets) are formed, which can be collected in a heated 1 liter Erlenmeyer flask attached to the bottom of the tube.

After completion of the addition, the oil is allowed to cool, and the spheres are collected by draining the oil. Excess oil is removed by washing with i-propanol, and the particles (spheres) are pre-dried by exposing them to excess i-propanol for 12-24 hours. Additional washings with i-propanol may be needed to remove traces of the silicone oil. The particles (spheres) are then dried in a vacuum oven at 60-100° C. until a constant weight is obtained.

The amount of MBAA may be adjusted, depending on what properties are required from the resulting polymers, e.g., when 0.3 mol % (per mol AA) MBAA is used, the resulting water-swellable polymer particles have a CCRC of about 50 g/g (absorption of 0.9% saline solution, as determined by methods known in the art and described herein); when 1.0 mol % (per mol AA) MBAA is used, the resulting water-swellable polymer particles have a CCRC of about 19 g/g; when 2.0 mol % (per mol AA) MBAA is used, the resulting water-swellable polymer particles have a CCRC of about 9 g/g.

All compounds were obtained by Aldrich Chemicals, and used without purification.

### EXAMPLE 1.2

### Process for the Preparation of AGM Useful Herein

To 300 g of glacial acrylic acid (AA), an appropriate amount of the core crosslinker (e.g., MethyleneBisAcrylAmide, MBAA) is added (see above) and allowed to dissolve at ambient temperature. A 2500 ml resin kettle (equipped with a four-necked glass cover closed with septa, suited for the introduction of a thermometer, syringe needles, and optionally a mechanical stirrer) is charged with this acrylic acid/crosslinker solution. Typically, a magnetic stirrer, capable of mixing the whole content, is added. An amount of water is calculated so that the total weight of all ingredients for the polymerization equals 1500 g (i.e., the concentration of AA is 20 w/w-%). 300 mg of the initiator (“V50” from Waco Chemicals) are dissolved in approx. 20 ml of this calculated amount of deionized water. Most of the water is added to the resin kettle, and the mixture is stirred until the monomer and water are well mixed. Then, the initiator solution is added together with any remaining water. The resin kettle is closed, and a pressure relief is provided, e.g., by puncturing two syringe needles through the septa. The solution is then spurged vigorously with argon via an 80 cm injection needle while stirring at ˜300 RPM. Stirring is discontinued after ˜8 minutes, while argon spurging is continued. The solution typically starts to gel after 12-20 minutes total. At this point, persistent bubbles form on the surface of the gel, and the argon injection needle is raised above the surface of the gel. Purging with argon is continued at a lowered flow rate. The temperature is monitored, typically it rises from 20° C. to 60-70° C. within an hour. Once the temperature drops below 60° C., the kettle is transferred into a circulation oven and kept at 60° C. for 15-18 hours.

After this time, the resin kettle is allowed to cool, and the resulting gel is removed into a flat glass dish. The gel is then broken or cut with scissors into small pieces (for example, in pieces smaller than 2 mm max. dimension), and transferred into a 6 liter glass beaker. The amount of NaOH (50%) needed to neutralize 75% of the acid groups of the polymer is diluted with deionized water to 2.5 liters, and added quickly to the gel. The gel is stirred until all the liquid is absorbed; then, it is covered and transferred into a 60° C. oven and let equilibrate for 2 days.

After this time, the gel is allowed to cool, then divided up into 2 flat glass dishes, and transferred into a vacuum oven, where it is dried at 100° C./max. vacuum. Once the gel has reached a constant weight (usually 3 days), it is ground using a mechanical mill (e.g., IKA mill) and sieved to obtain AGM particles of the required particle size, e.g., 150-800 μm.

The amount of MBAA may be adjusted, depending on what properties are required from the resulting polymers, e.g., when 0.01 mol % (per mol AA) MBAA is used, the resulting AGM particles have a CCRC of about 90 g/g (absorption of 0.9% saline solution, as determined by methods known in the art and described herein); when 0.03 mol % (per mol AA) MBAA is used, the resulting AGM polymer particles have a CCRC of about 73 g/g; when 0.1 mol % (per mol AA) MBAA is used, the resulting AGM particles have a CCRC of about 56 g/g; when 2.0 mol % (per mol AA) MBAA is used, the resulting AGM particles have a CCRC of about 16 g/g; when 5.0 mol % (per mol AA) MBAA is used, the resulting AGM particles have a CCRC of about 8 g/g. (All compounds were obtained by Aldrich Chemicals, and used w/o purification.)

### EXAMPLE 1.3

### Surface Cross-Linking Process Step

This example demonstrates surface crosslinking of AGM prior to subjecting them to the process step a) and b) of the invention, whereby said step b) then does not comprise a surface-cross-linking step, but preferably a coating step (whereby the treatment agent is a coating agent).

A 150 ml glass beaker is equipped with a mechanical stirrer with a plastic blade, and charged with 4 g of a dry AGM in particulate form. The mechanical stirrer is selected in such a way that a good fluidization of the polymers can be obtained at 300-500 RPM. A 50-200 μl syringe is charged with a 4% solution (w/w) of DENACOL (=EthyleneGlycolDiGlycidylEther=EGDGE) in 1,2-propanediol; another 300 μl syringe is charged with deionised water.

The AGM is fluidized in the beaker at approx. 300 RPM, and the surface cross-linking agent is added within 30 seconds. Mixing is continued for a total of three minutes. While stirring is continued, 300 μl of water are then added within 3-5 seconds, and stirring is continued at 300-500 RPM for another 3 minutes. After this time, the mixture is transferred into a glass vial, sealed with aluminum foil, and let equilibrate for 1 hour. Then the vial is transferred to a 140° C. oven, and kept at this temperature for 120 minutes. After this time, the vial is allowed to cool down, the contents is removed, and the surface cross-linked AGM is obtained. Any agglomerates may be carefully broken by gentle mechanical action. The resulting surface cross-linked AGM particles may then be sieved to the desired particle size and then used to obtain the water-containing AGM of step a).

The following examples exemplify possible treatment steps b) of the process of the invention.

### EXAMPLE 2.1

### Process of Providing Coated AGM By Directly Mixing AGM Into a Water Based Latex Dispersion (Steps a) and b) Are Done at the Same Time)

The following is a preferred process for making the water-swellable material of the invention, involving swelling the AGM simultaneously with the treatment step.

The amount of AGM to be coated, coating level and water needed to swell the water-swellable polymers is chosen.

Then, the diluted dispersion of the coating agent is prepared, e.g., of a wet-extensible coating material such as latex, as described herein; this is done under stirring, for example in a glass beaker using magnetic stirrers at about 300 rpm for about 5 minutes. At all times, care needs to be taken that no film is formed on the surface of the dispersion. Typically for latex dispersions, the dispersion contains at the most 70% by weight of wet-extensible polymer.

In order to monitor the coating process better, a staining color might be added to the dispersion, for example New Fuchsin Red.

Then, a mechanical stirrer with a double cross Teflon blade is used and the dispersion is stirred such that a vortex can be seen, the AGM (particles) is quickly added under continuous stirring. Once the AGM start absorbing the water from the dispersion, forming the water-containing AGM of step a), (typically after about 15 seconds), the mixture will start to gel and the vortex will eventually disappear. Then, when about all of the free liquid has been absorbed, the stirring is stopped and the resulting coated AGM may be dried or post treated by any of the methods described herein.

### EXAMPLE 2.2

### Process of Providing Individually Coated Water Swellable Materials

An alternative preferred coating process of the invention is as follows:

The water-containing AGM (e.g., having a water content of 10 g per gram AGM, e.g., a CCRC of 10 g/g) is placed on a surface that is preferably under an angle (30-45 degrees).

The coating agent, in the form of a dispersion, is applied in drops, e.g., by use of a pipette or by spraying, onto the polymers. Hereby, no air bubbles should be formed.

Thus, a film is formed on the surface of the water-containing AGM.

The coated, water-containing AGM (particles) is then dried, either at room temperature (20° C.), or for example at 40° C./80% humidity, for up to 2 days, or for example in an oven (if required, a vacuum oven) at a low temperature (up to 80° C.).

The coated AGM may then be cured as described herein. It may then also be formed into the desired form, e.g., particles.

### EXAMPLE 2.3

### Alternative Preferred Coating Process

In another preferred process, a dispersion of the water-containing AGM is prepared first and the coating agent is added thereto.

For example, 2200 grams of a water-containing AGM (200 grams AGM and 2000 grams water; the water content being such that the material has a CCRC of 10 g/g, for example prepared by the method described above) is placed in a vessel and n-heptane is added, until the heptane stands about 1-2 mm above the surface of the polymers in the beaker.

Using a household mixer (e.g., for whipping cream), the components are mixed at high speed. The coating agent, in the form of a water dispersion of a wet-extensible coating material, e.g., a latex dispersion as described above, is added to the beaker with the water-swellable polymers by use of for example a pipette. The mixture is continuously stirred, avoiding the formation of lumps.

The resulting material can be spread out over a surface as a thin layer (e.g., less than 1 cm) and allowed to air dry for at least 12 hours or in a (vacuum) oven (any temperature up to about 70 C). The dried coated AGM may then additionally be cured by heating to 140° C. or 150° C. in a (vacuum) oven.

After cooling or subsequent steps, the resulting material may be mechanically reduced or sieved to the desired particle sizes.

### EXAMPLE 2.4

### Surface Treatment of Water-Containing AGM By Interfacial Polymerization

The following reaction is performed in a 1 liter fluted resin kettles equipped with a Trubore mechanical stirrer with Teflon blade, immersion thermometer, and Barrett type moisture receiver equipped with a water-cooled Friedrichs condenser. A digital stir motor is used to control the stirring speed. Teflon gaskets and sleeves are used for all glass-to-glass connections. A heating mantle is used to regulate the temperature.

350 mls of cyclohexane is added to the resin kettle. Then, 0.5 grams of the emulsifier Span 40 (ICI sorbitan monopalmitate) is added to the cyclohexane.

The cyclohexane is heated with gentle stirring to approximately 60° C. to dissolve the Span 40.

Then 10.0 grams of the dry AGM is added to the cyclohexane and dispersed with stirring at approximately 150 rpm. While stirring, 40 grams of distilled/deionized water is added dropwise to the particle suspension.

After all of the water is absorbed by the AGM, obtaining thereby water-containing, partially swollen AGM of step a), the stirring speed is increased to approximately 300 rpm and the suspension of the partially swollen AGM is equilibrated for approximately 30 minutes.

Separately, a 1% aqueous solution of polyethylenimine (MW=600; Polysciences) is prepared by dissolving 0.10 gram of polyethylenimine in 9.90 grams of distilled/deionized water.

This solution is added dropwise to the resin kettle with the suspension of the pre-swollen AGM and this mixture is equilibrated for 15 minutes.

Separately, 0.26 g of isophthaloyl dichloride (Aldrich) obtained from a freshly-opened bottle is dissolved in approximately 30 mls of cyclohexane.

While continuing to stir at approximately 300 rpm, the isophthaloyl dichloride solution is added dropwise to the mixture.

The resulting mixture is maintained at 60° C. for approximately two hours to effect the interfacial polymerization reaction.

The resultant surface treated AGM, containing water, are dewatered (dried) via azeotropic distillation (for example as described herein below). The dewatered surface treated AGM is then filtered, rinsed with hot cyclohexane to remove residual Span 40, and then further dried for approximately 64 hours at ambient temperature under vacuum.

If desired, the resulting surface treated AGM may be sieved, for example through a number 20 sieve to remove highly-agglomerated particles. 8.1 grams of sieved product is obtained.

### EXAMPLE 2.5

### Preferred Process Steps of Drying and/or Curing

The process of the invention comprises typically a drying step and optionally a curing step.

The following is a preferred process step of drying the surface-treated, water-containing AGM of step b):

The surface treated AGM comprising a liquid, e.g., water, is placed on a surface, for example, it is spread out in a Pyrex glass pan in the form of a layer which is not more than about 1 cm thick. This is dried at about 70 Celsius for at least 12 hours.

If the amount of liquid present in the surface treated AGM is known, then, by measuring the weight of the surface-treated water-containing AGM prior to drying and then weighing it subsequently after drying, one can determine the residual moisture in the resulting surface treated AGM. Typically, the surface treated AGM will be dried to less than 5% (by weight of the material) water content.

The surface treated AGM may subsequently be cured, for example in a vacuum oven at 140 Celsius for 2 hours.

For some type of treatment agents, the surface treated AGM may potentially form agglomerates. Flow aids may be added prior to or during the treatment step, or preferably during the drying and/or curing step, as known in the art, e.g., Aerosil 200, available from Degussa.

The above drying step may also be done by spreading the surface treated water-containing AGM on a Teflon coated mesh in a very thin layer, e.g., less than 5 mm, such as to enable convection through the layer.

As alternative method, the surface treated AGM that contains a liquid (water), may also be directly dried and cured in one step, e.g., placing the material in a vacuum oven at 140 Celsius for 2 hours.

### EXAMPLE 2.6

### Method of Azeotropic Distillation and Drying

The surface treated water-containing AGM may be dried or dewatered at low-temperature via azeotropic distillation from a suitable liquid, for example cyclohexane. For example, the material is transferred to a 2 liter resin kettle, equipped with a Trubore mechanical stirrer with Teflon blade and digital stirring motor, immersion thermometer, and Barrett type moisture receiver with graduated sidearm and water-cooled condenser. Approximately one liter of cyclohexane is added to the resin kettle. While stirring, a heating mantle is used to raise the temperature of the stirred cyclohexane/gel system to reflux. Reflux is continued until the temperature of the system approaches the boiling point of cyclohexane (approximately 80° C.) and only minimal additional quantity of water is delivered to the sidearm. The system is cooled and then filtered to obtain the dewatered or dried, surface-treated AGM of the invention, which may be further dried overnight under vacuum at ambient temperature (20° C.).

Test Methods Used Herein:

(Unless specified otherwise, each test to obtain a value parameter herein is done 3 times to obtain an average of 3 values)

Determination of Cylinder Centrifuge Retention Capacity of Water-Swellable Materials

This test serves to measure the saline-water-solution retention capacity of the AGM or surface-treated AGM (“sample”) used herein, when the AGM or surface treated AGM are submitted to centrifuge forces (and it is an indication of the maintenance of the absorption capacity of the polymers in use, when also various forces are applied to the material).

First, a saline-water solution is prepared as follows: 18.00 g of sodium chloride is weighed and added into a two liter volumetric flask, which is then filled to volume with 2 liter deionised water under stirring until all sodium chloride is dissolved.

A pan with a minimum 5 cm depth, and large enough to hold four centrifuge cylinders is filled with part of the saline solution, such that up to a level of 40 mm (±3 mm).

Each sample is tested in a separate cylinder and each cylinder to be used is thus weighed before any sample is placed in it, with an accuracy of 0.01 g. Each cylinder has a very fine mesh bottom, to allow liquid to escape from the cylinder (but to hold the AGM or surface-treated AGM).

For each measurement, a duplicate test is done at the same time; so two samples are always prepared as follows:

1.0 g of the AGM or surface treated AGM which is to be tested is weighed, with an accuracy of 0.005 g (this is the ‘sample’), and then the sample is transferred to an empty, weighed cylinder. (This is repeated for the replica.)

Directly after transferring the sample to a cylinder, the filled cylinder is placed into the pan with the saline solution (Cylinders should not be placed against each other or against the wall of the pan).

After 15 min (±30 s), the cylinder is removed from the pan, and the saline solution is allowed to drain off the cylinder; then, the cylinder is re-placed in the pan for another 15 min. After the total of 2×15 minutes=30 minutes immersion time, the cylinder is taken from the solution and excess water is allowed to run off the cylinder and then, the cylinder with the sample is placed in the cylinder stands and inside a centrifuge cup, such that the two replicate samples are in opposite positions.

The centrifuge used may be any centrifuge equipped to fit cylinder and cylinder stand into a centrifuge cup that catches the emerging liquid from the cylinder and capable of delivering a centrifugal acceleration of 250 G (±5 G) applied to a mass placed on the bottom of the cylinder stand (e.g., 1300 rpm for a internal diameter of 264 mm). A suitable centrifuge is Heraeus Megafuge 1.0 VWR # 5211560. The centrifuge is set to obtain a 250 G centrifugal acceleration. For a Heraeus Megafuge 1.0, the setting of the centrifuge is 1300 rpm.

The samples are centrifuged for 3 minutes at 250 G (±10 s).

The cylinders are removed from the centrifuge and weighed to the nearest 0.01 g.

For each sample (i), the cylinder centrifuge retention capacity Wi, expressed as grams of saline-water-solution absorbed per gram of water-swellable polymer is calculated as follows:

$${w}_{i} = \frac{{m}_{CS} - ( {m}_{Cb} + {m}_{S} )}{{m}_{S}} [ \frac{g}{g} ]$$

where:
m_{CS}: is the mass of the cylinder with sample after centrifugation [g]
m_{Cb}: is the mass of the dry cylinder without sample [g]
m_{S}: is the mass of the sample without saline solution [g]

Then, the average of the two Wᵢ values (i.e., for the sample and its replica) is calculated values (to the nearest 0.01 g/g) and this is the CCRC as referred to herein.

Saline Flow Conductivity (SFC)

A measure of permeability and an indication of porosity is provided by the saline flow conductivity of the gel bed of AGM or surface-treated AGM, as described in U.S. Pat. No. 5,562,646, (Goldman et al.) issued Oct. 8, 1996 (but using in this test a 0.9% NaCl solution).

Extractables or Extractable Polymers Value

Another important characteristic of particularly preferred AGM useful in the present invention is the level of extractable polymer material or extractables present therein. Evaluation and explanation of which levels of extractable polymer is still acceptable is disclosed and explained in detail in EP-A-752 892. As a general rule the extractable amount should be as low as possible and the lower it is the less undesired reaction the extractable material can cause.

Preferred are levels of extractables of less than 10% by weight, or even less than 5% or even less than 3%, or even less than 1% by weight of the AGM (1 hour test results values).

Method to Determine the Free Swell Rate of AGM or Surface Treated AGM Herein

This method serves to determine the swell rate of the AGM or surface-treated AGM herein in a 0.9% saline solution, without stirring or confining pressure. The amount of time taken to absorb a certain amount of fluid is recorded and this is reported in gram of fluid (0.9% saline) absorbed per gram of AGM or surface treated AGM per second, e.g., g/g/sec.

The saline solution is prepared by adding 9.0 gram of NaCl into 1000 ml distilled, deionized water, and this is stirred until all NaCl is dissolved.

1.0 gram of the sample material is weighed (to an accuracy of 0.0001 g) and placed evenly over the bottom of a 25 ml beaker; then 20 ml of the saline solution (also at 23 C) is added quickly to the beaker with the sample and the timer is started.

When the last part of the undisturbed fluid surface meets the swelling sample, e.g., judged by the light reflection from the fluid surface, the time tₛ is recorded.

The test is repeated twice, to obtain 3 values.

The free swell rate can then be calculated per sample and this can be averages to obtain the Free swell rate, as referred herein (e.g., 20 gram water absorbed by 1.0 gram water-swellable material in tₛ).

Preparation of Films of the Coating Agent

In order to subject the coating agents used as treatment agents herein (in the process step b) of the invention) to the test methods below, films need to be obtained of said coating agents (or wet-extensible polymeric material thereof, as described above).

Methods to prepare films are generally known to those skilled in the art and typically comprise application of the coating agent as a layer to a flat substrate, forming a film of the coating agent and curing the film, and then subsequently gently removing the film from the substrate. These films are then subjected to the test methods below.

For evaluation in the test methods outlined below, films with a caliper of about 100 μm to about 600 μm may be used. The preferred average caliper of films for evaluation is around 400 μm.

### An Example to Prepare a Film Herein is from a Wet-Extensible Polymeric Material

Polymeric films can be prepared by casting the films from a solution or dispersion of the wet-extensible polymer. The solution is normally prepared by dissolving or dispersing the polymer at a 20% by weight level, in a suitable liquid or solvent such as water, or if this is not possible, in THF (tetrahydrofuran), or if this is not possible, in dimethylformamide, or if this is not possible in methyl ethyl ketone, or if this is not possible, in dichloromethane or if this is not possible in toluene or if this is not possible, in cyclohexane. (If none of these solutions or dispersion can be formed, the hot melt extrusion process below is used).

Next, the dispersion or solution is poured into a Teflon boat and the solvent is evaporated at a temperature above the minimum film forming temperature of the polymer, typically about 35 C, for a long period of time, e.g., during at least 48 hours, or even up to 7 days. For the drying it is important to slow down evaporation by covering the drying films during drying, for example using aluminum foil. If the liquid content is above 5%, the film may then placed in a vacuum oven to remove the residual solvent, for 6 hours, at 25° C., to ensure any remaining solvent is removed.

The process to prepare a hotmelt extruded film herein is as follows:

If the solvent casting method is not possible, the films herein may be extruded from a hot melt using a rotating single screw extrusion set of equipment operating at such a temperature that extrusion is possible. For example, if the coating agent or material has a melt temperature Tm, then the extrusion should takes place at least 20° C. above said Tm of the polymer. If the coating agent or wet-extensible material is amorphous (i.e., the polymer does not have a Tm), steady shear viscometry can be performed to determine the order to disorder transition for the polymer, or the temperature where the viscosity drops dramatically. The extrusion temperature should be below the decomposition temperature of the material or coating agent.

### Curing of the Films

The film, obtained by any film-forming method, or for example the method above, is then cured, by placing the film in a (vacuum) oven at 140° C. for 2 hours.

Wet-Extensibility Test and Wet-tensile Test:

This test method is used to measure the wet-extensibility and tensile properties of films of preferred polymeric, film-forming treatment (i.e., coating) agents as used herein, by applying a uniaxial strain to a rectangular flat sample and measuring the force that is required to elongate the sample. The films used for the evaluation are prepared by the method above.

A preferred piece of equipment to do the tests is a ZWICK Type Z 1.0/TH1S tensile tester available from Zwick GmbH & Co, August-Nagel-Str. 11, 89079 Ulm, Germany with a 100 Newton load cell and the Zwick testXpert® software. This measures the Constant Rate of Extension in which the pulling clamp moves at a uniform rate and the force measuring mechanisms moves a negligible distance (less than 0.13 mm) with increasing force. The clamps are motor driven and have a travel distance of at least about 1 m. Load cell must be chosen, so that the force results of the samples tested will be between 10 and 90% of the capacity of the load cell or load range used.

The tensile tester has rectangular flat face jaws of about 6 cm width in cross direction of the pulling force and 3 cm length in the pulling direction. The jaws are air activated with an air pressure of about 4-6 Bar. The jaws need to clamp the test sample enough so that it does not slip out the clamps during testing but gently enough so that the sample is not destroyed by too high pressure of the jaws.

The tensile tester must be calibrated according to the instructions of the manufacturer.

The test is performed at standard laboratory conditions of 50% relative humidity (+/−2%) and 23 Celsius (+/−2 Celsius).

Polymeric films that are suitable for testing can be obtained by film forming methods known to the skilled in the art and or exemplified. If the process embodiment involves a curing step and the resulting water-sellable material is obtainable by a process involving a curing step, the films used in this test method are cured as described above (at a temperature of 140 C for 2 hours).

The average caliper of the film suitable for testing will be between 100 and 600 microns, preferably the average caliper herein is about 400 microns, with a minimum caliper of 100 microns and a maximum caliper of 700 microns. The caliper of the sample is measured with typical low pressure caliper gauge such as Mitutoyo Caliper Gauge with a pressure of about 0.09 psi with an accuracy of 0.001 mm in 3 different areas of the sample and the average is taken.

A polymeric film that has been obtained as described above is cut into rectangular samples of 10 mm width and at least 50 mm in length. Samples need to be cut with very sharp cutters such as precision sample cutters. Typical equipment used is the Sample Cutter IDEAL 1036 A from Ideal-Werk, Balingen, Germany.

It may be important that the film samples are substantially free of visible defects such as air bubbles, holes, inclusions, cuts as well as have sharp and substantially defect-free borders. The samples are equilibrated at the laboratorium conditions mentioned above, for 2 hours.

Then, the cut sample is weighed using a standard laboratory scale with an accuracy of 0.001 g and the dry sample weight is recorded. The cut sample is soaked in deionized water for about 2.5 hours at laboratory temperature as specified above, to obtain a wet sample. After absorption the sample is removed from the water and excess water is gently blotted away. The wet sample is then weighed again.

The water absorption of the sample is determined as follows:

Water absorption (in g/g)=(Wet Sample Weight [g]−Dry Sample Weight [g])/Dry Sample Weight [g].

The water absorption as determined is called Swellability Capacity of the Film Sample.

The film average caliper, length and width of the wet sample are measured with the defined equipment; the sample is then used directly for tensile testing.

Then, the tensile tester software is started and the parameters are set to the following test conditions:

| Parameter | Setting |
|---|---|
| Gauge Length (=Grip to Grip Distance) | 10 mm |
| Cross head speed | 100 mm/min |
| (=constant strain rate) during test | |
| Pre-Load (No dwell time) | 0.05 N |
| Pre-Load speed | 10 mm/min |
| Zero force after preload | Yes |
| Break Detector | 80% of Peakforce (Fmax) |
| Max. Strain | 10000% |
| Specimen shape | Flat specimen |

The program should at least record the following data:
Strain in % and Stress at strain in MPa for the tensile curve (in steps no larger than 5% of absolute strain)
Elongation to Break in %
Stress at Break in %
Specimen dimensions, gauge length

As the test is performed on the wet samples, for the purpose of the present invention the Elongation to Break will be called Wet Elongation to Break and the tensile stress at break will be called Wet Stress at Break.

At the point of breakage, the wet elongation to break % is the wet extensibility % as used herein.

The tester is calibrated and the force of the load cell is set to zero. One end of the film sample is inserted into the static jaw, which is then closed. The opposite end of the film sample is inserted into the moving jaw, which is then closed with enough tension to eliminate any slack, but less than 0.05 N of force on the load cell.

The tensile tester is started and the above-mentioned data is collected (as described by the manufacturer's instructions.

The instrument should operate until the entire sample breaks. If the film sample breaks at the jaw line it should be discarded for this test.

For determination of wet-extensibility and tensile stress values as used herein, a minimum of 3 samples per coating agent should be measured, to get an average value of 3 samples, e.g., the average wet-extensibility of 3 samples is herein referred to as’ the wet-extensibility’ which should be at least 200%.

For the determination of the average Elastic Modulus at Break, the wet tensile curves determined by the method above are evaluated and the average elastic modulus is determined as follows:
Average Wet Elastic Modulus at Break=Wet Stress at Break/Wet Elongation at Break

### References

The general conditions from the following standard test methods apply unless noted specifically herein
EDANA ERT 20.2-99 “Nonwoven Tensile Strength”
ASTM D 76-99 “Standard Specification for Tensile Testing Machines for Textiles”
ASTM D 1566-00 b “Standard Terminology Relating to Rubber”
ISO 9073-3: 1969 “Determination of Tensile Strength and Elongation”

### Definitions

Preload: This procedure will compensate for slack that may be present in the sample when loaded by finding the first point at which the measured load (force) exceeds the input preload (in this method 0.05 N) and assigning an elongation value of zero to this point.

Break Sensitivity: The break sensitivity for real time break detection is the percentage of the peak load used to define when the sample breaks.

Break Point: For calculations, the break point is defined as the first point after the peak load at which the load drops by a given percentage of the peak.

% Elongation: The distance the crosshead moved divided by the gauge length expressed as percentage (% Elongation=crosshead distance*100%/gauge length).

Stress: The force that the sample exerts between the clamps divided by the cross-section area of the sample transverse to the direction of pulling.

Stress at Break: The maximum stress developed in the test specimen before rupture for a test carried out as described below.

Method of Determining the Water Swellability Capacity/Absorption Capacity of the Wet-Extensible Material Used in Preferred Coating Agents Herein

The water absorption/swellability capacity of the wet-extensible material used herein in a preferred treatment agent, can be determined as follows.

A certain, pre-weighed amount of a wet-extensible material with weight M(sample), is immersed in an excess amount of deionized water and are allowed to ‘absorb’ water for about 2.5 hours.

The sample is gently removed from the water; if possible, excess water is blotted from the sample with tissue towel for few seconds. The sample is then weighed again and the wet sample weight M (sample-wet) is determined.

The water absorption capacity or swellability/swelling capacity of the sample, X (AC sample), is determined by the following formula:
X(AC sample)={M(sample wet)−M(sample)}/M(sample)

The value X is reported in gram of absorbed fluid per gram of dry film sample.

The wet-extensible, preferably elastomeric polymers, herein are typically non-water-swellable or water-absorbing, which means in general that such a (components of) coating agent absorbs the water typically in an amount of less than 0.5 g/g or even less than 0.2 g/g/or even less than 0.1 g/g, as determined by the method above.

Determination of the Coating Caliper and Coating Caliper Uniformity

The surface-treatment layer which is a coating on the surface-treated AGM as described herein can typically be investigated by standard scanning electron microscopy, preferably environmental scanning electron microscopy (ESEM) as known to those skilled in the art. For example, the caliper and uniformity of the coating layer or shell, or of the coating (layer or shell) can be determined.

In the following method the ESEM evaluation is also used to determine the average caliper and the caliper uniformity of the coated AGM of the invention, via cross-section of the materials.

Equipment model: ESEM XL 30 FEG (Field Emission Gun)

ESEM setting: high vacuum mode with gold covered samples to obtain also images at low magnification (35×) and ESEM dry mode with LFD (large Field Detector which detects ˜80% Gaseous Secondary Electrons+20% Secondary Electrons) and bullet without PLA (Pressure Limiting Aperture) to obtain images of the latex shells as they are (no gold coverage required).

Filament Tension: 3 KV in high vacuum mode and 12 KV in ESEM dry mode.

Pressure in Chamber on the ESEM dry mode: from 0.3 Torr to 1 Torr on gelatinous samples and from 0.8 to 1 torr on the remaining samples.

Samples can be observed after about 1 hour at ambient conditions using the standard ESEM conditions/equipment. Then, the same samples can be observed in high vacuum mode, prior to the samples are cut and after the samples are cut by a cross section cut with a Teflon blade (Teflon blades are available from the AGAR scientific catalogue (ASSING) with reference code T5332).

The coated AGM has a different morphology than the untreated AGM and the coating layer or shell is clearly visible in the ESEM images, in particular when observing the cross-sectional views.

The average caliper of the coating layer/shell is determined then by analyzing at least 5 particles of the coated AGM and determining the average caliper of each particle by analyzing a cross-section of each particle and measuring the caliper of the coating in at least 3 different areas and taking the average thereof. The uniformity of the coating layer or shell is determined by determining the minimum and maximum caliper via ESEM of x-sectioned particles for at least 5 different particles.

If the coating is not clearly visible in ESEM, then staining techniques known to the skilled in the art that are specific for the coating applied may be used such as enhancing the contrast with osmium tetraoxide, potassium permanganate and the like, e.g., prior to using the ESEM method.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process for making surface-treated absorbent gelling material that comprises water-swellable polymers, said process comprising the steps of:
a) obtaining absorbent gelling material that contains per gram of absorbent gelling material at least 4 gram of liquid, typically water;
b) treating the surface of the absorbent gelling material of step a) with a treatment agent;
c) removing at least a part of the water from said absorbent gelling material, to obtain surface-treated absorbent gelling material containing less than 50% by weight of moisture.

2. A process for making surface-treated absorbent gelling material that comprises water-swellable polymers, said process comprising the steps of:
a. obtaining absorbent gelling material that contains per gram of absorbent gelling material at least 1.0 gram of water and that has a CCRC of at least 60 g/g;
b. treating the surface of the absorbent gelling material of step a) with a treatment agent;
c. removing at least a part of the water from said absorbent gelling material, to obtain surface-treated absorbent gelling material containing less than 50% by weight of moisture.

3. A process according to claim 1, wherein the absorbent gelling material in step a) is in solid form, preferably in the form of particles, fibers, spheres, flakes, cubes, disks, platelets and/or agglomerates.

4. A process according to claim 1, wherein in step b) the treatment agent comprises a cross-linking agent and the surface of the absorbent gelling material is at least partially cross-linked and/or surface-cross-linked by said agent.

5. A process according to claim 1, wherein in step b) the treatment agent comprises polymerizable material.

6. A process according to claim 1, wherein in step b) the treatment agent comprises a coating agent and the surface of the absorbent gelling material is coated.

7. A process according to claim 6, wherein the coating agent comprises a polymeric material.

8. A process as in claim 7, wherein the coating agent comprises polymeric elastomeric material having an elongation to break in the wet state of at least 200%, preferably at least 500%, more preferably at least 1000%.

9. A process as in claim 8, wherein the coating agent comprises polymeric elastomeric material having a tensile stress at break in the wet state of at least 1 MPa.

10. A process as in claim 9, wherein the polymeric elastomeric material has an average elastic modulus to break in the wet state of at least about 0.1 MPa.

11. A process as in claim 1, wherein in step b) a shell is formed on the surface of at least part of the material, preferably said part of the material being in solid form, said shell having an average calliper of 1 μm to 100 μm.

12. A process as in claim 1, wherein step a) and b) are done simultaneously, by mixing an absorbent gelling material, or precursors thereto, water and a treatment agent.

13. A process as in claim 11, wherein step b) is done by contacting the absorbent gelling material with an aqueous composition comprising the treatment agent.

14. A process as in claim 1, wherein in step c), the resulting material of step b) is subjected to a temperature of at least 60° C., but less than 300° Celsius, for at least 5 minutes.

15. A process as in claim 1, wherein, subsequent to the drying step c), the resulting surface-treated water-swellable polymers are cured by a means selected from temperature treatment, irradiation or a combination thereof.

16. A surface-treated absorbent gelling material obtainable by a process of claim 1.

17. A surface treated absorbent gelling material of claim 16 comprising as treatment agent comprising an elastomeric polymeric material selected from the group consisting of natural rubber, synthetic rubber and thermoplastic elastomers that are elastic at 35° C.

18. A surface treated absorbent gelling material of claim 17, comprising as treatment agent comprising one or more polymers selected from the group consisting of co-polymers, and/or blockcopolymers of ethylene; vinyl compounds; polyunsaturated monomers; polyurethanes; polyethers; polydimethylsiloxanes; and proteins; which may optionally be grafted and/or be (partially) modified with chemical substituent groups.

19. A solid or particulate surface-treated absorbent gelling material as in claim 18, wherein the treatment agent is applied such that it is present in an amount of 0.5% to 50% by weight of the material.

20. A surface treated absorbent gelling material as in claim 19, having as surface treatment, a coating or shell, which is wrinkled.

21. An absorbent structure, suitable for disposable absorbent articles, comprising the surface treated absorbent gelling material as in claim 16.

22. A disposable absorbent article comprising the absorbent structure according to claim 21.
